(19) United States
(12) Patent Application Publication
(10) Pub. No.: US 2019/0102802 A1
(43) Pub. Date: Apr. 4, 2019

(54) PREDICTING PSYCHOMETRIC PROFILES FROM BEHAVIORAL DATA USING MACHINE-LEARNING WHILE MAINTAINING USER ANONYMITY

(71) Applicant: Pinpoint Predictive, Inc., San Mateo, CA (US)

(72) Inventors: Avi Tuschman, San Mateo, CA (US); Evan Zamir, San Francisco, CA (US); Wei Nan Hsu, Hillsborough, CA (US)

(21) Appl. No.: 16/208,591

(22) Filed: Dec. 4, 2018

Related U.S. Application Data
(63) Continuation of application No. PCT/US2017/036875, filed on Jun. 9, 2017.
(60) Provisional application No. 62/352,705, filed on Jun. 21, 2016.

(51) Int. Cl. G06Q 30/02; G06N 20/20; G06F 16/31; G06F 16/9035

(52) U.S. Cl. CPC G06Q 30/0269; G06F 16/9035; G06F 16/313; G06N 20/20

(57) ABSTRACT

A method and system provides for: training at least one machine-learning method of predicting psychometric profiles of individual users in an online population based on automatically collected records of their online behavior; using the resulting predicted psychometric profiles and engagement data on users to learn an engagement model of likelihood of engaging with a stimulus based on psychometric dimensions; and using the engagement model on a population to determine audiences for the stimulus ranked according to predicted likelihood of engagement. The method and system are able to maintain anonymity of the users.

### RELATED APPLICATIONS

The present application is a continuation of International Pat. Appl. No. PCT/US2017/036875 to Applicant Pinpoint Predictive, Inc., having an International Filing Date of 2017 Jun. 9 and including US as a designated state. Said PCT/US2017/036875 claims priority of U.S. Provisional Pat. App. No. 62/352,705 filed 2016 Jun. 21 to inventor Avi Tuschman and titled ARTIFICIAL INTELLIGENCE OPTIMIZATION OF PSYCHOGRAPHIC AUDIENCE DATA SETS. U.S. Provisional Pat. App. No. 62/352,705 is called the Parent Provisional Application herein, and its contents are incorporated herein by reference in any jurisdiction in which incorporation by reference is permitted, including the U.S.A. In any jurisdiction in which incorporation by reference is not permitted, Applicant reserves the right to insert any material from the Parent Provisional Application by amendment without such amendment being considered as adding new matter.

### FIELD OF THE INVENTION

The present disclosure relates to using machine-learning to generate psychometric models for use in online targeting and other applications, and more specifically to an apparatus (a machine) and a machine-implemented machine-learning method of predicting psychometric profiles of online users of a population based on automatically machine-collected data about online behavior of such users, the method of predicting enabling the maintaining of user anonymity. The present invention also relates to an apparatus and machine-implemented method that uses such machine-learning-generated psychometric models to generate online audiences likely to respond in a desired manner to a pre-defined online stimulus such as an advertisement.

### BACKGROUND

It is known to automatically collect behavioral data of online users using machines, and then to use the automatically machine-collected users' behavioral data as inputs for machine-implemented methods to target particular users to electronically send such users information such as digital advertisements. The goal of automatically collecting such behavioral data is to effectively target the digital advertisements to users likely to respond in a desired manner, e.g., to purchase a product, or to otherwise respond in a desirable manner.

Such machine-implemented targeted advertising is called “behavioral advertising” herein because it is solely and directly based on behavior, and the machine-implemented methods are collectively called “machine-implemented behavioral targeting.”

Machine-implemented behavioral targeting is backward-looking; it may predict if a user is likely to visit a web page that they've already visited, or purchase a product they've already purchased. Data such as these can be used effectively for carrying out machine-implemented targeting or retargeting advertisements to a user, even though, using an advertisement to purchase something as an example, the user may have already made a purchase by the time they see the advertisement. Machine-implemented behavioral targeting also is specific to the context in which it was collected, e.g., the types of websites that were visited, and as a result targeting based solely and directly on such past behavior may be overly narrow in scope, and for example may lead to overexposure of advertisements for very similar products. The combination of being backward-looking and context-specific might lead to users' sense that their privacy is being invaded, e.g., by users' receiving advertisements related to websites they've recently visited. Machine-implemented behavioral advertising additionally may not be able to easily differentiate between users who are likely to buy the same product for different reasons, or even between users who buy the product they've browsed for and those who do not. Furthermore, behavioral targeting uses data that changes over time is different for different populations, such that the data used by behavioral targeting may not be easily amenable to standardization, quantification, psychometric validation, or meaningful comparison across different populations.

Thus, there is a need in the art for improved computer-implemented methods, apparatuses, and systems for machine-implemented targeting usable for machine-implemented targeting of electronic messages such as advertising to particular sets of online users (online audiences).

### BRIEF DESCRIPTION OF THE DRAWINGS

Various embodiments in accordance with the present disclosure will be described with reference to the drawings, in which:

FIG. 1 is an illustrative example of a computing environment for carrying out at least one aspects of the present invention.

FIG. 2 shows a simplified flow chart of an embodiment of a method of operating a machine to generate psychometric models of online users from automatically generated online behavior of the users.

FIG. 3 shows a simplified flow chart of an embodiment of a method of operating a machine to determine a model of likelihood of engagement with a particular stimulus such as an advertisement by a user as a function of a psychometric model of the user.

FIG. 4A is an illustrative example of data flow and processes for generating psychometric models of a population of users from automatically machine-collected behavioral data on the users according to at least one embodiment of the present invention.

FIGS. 4B-4E show illustrative examples of data flows and processes of alternative embodiments of the invention to that shown in FIG. 4A for generating psychometric models of a population.

FIG. 5 is an illustrative example of data flow and processes for predicting audiences for a stimulus such as an advertisement from psychometric models of a population of users based on engagement data collected using a subset of the users according to at least one aspect of the present invention.

FIG. 6 shows a hardware system for generating psychometric models of online users based on automatically generated online behavior of the users.

FIGS. 7A and 7B show human personality dimensions used as the purely psychometric traits of a psychometric profile in some embodiments of the invention.

FIG. 8 is an illustrative example of a psychometric profile of a user having an anonymized user ID for profiles that use a different set of psychometric dimensions to those shown in FIGS. 7A-7B.

FIGS. 9A and 9B show a graphic display in terms of the purely psychometric and the demographic dimensions, respectively, of an example engagement model using the type of psychometric profile shown in FIG. 8, determined according to an embodiment of the present invention.

FIG. 10A shows in table form part of a ranking in likelihood of engagement with a stimulus (e.g., an online advertisement) of a population according to designated market areas determined using an example engagement model determined according to an embodiment of the invention.

FIG. 10B shows a map of designated market areas in the United States, wherein each such area can be coded according to likelihood of engagement using data such as shown in FIG. 10A.

### DETAILED DESCRIPTION OF EXAMPLE EMBODIMENTS

### Overview

The present disclosure relates to using machine-learning to generate psychometric models for use in online advertising, and more specifically to an apparatus (a machine) and a machine-implemented method of generating psychometric models of online users of a population based on automatically machine-collected data about online behavior of such users, the method of generating the models determined using machine-learning, and including maintaining user anonymity, e.g., by only using anonymized user IDs. The present invention also relates to an apparatus and machine-implemented method that uses such machine-learning-determined psychometric-models to generate online audiences likely to respond in a desired manner to a pre-defined online stimulus such as an advertisement.

The problems solved by embodiments of the invention, namely using machine-learning to generate psychometric models, and using such machine-learning-generated psychometric-models to predict online audiences specifically arise in the realm of computer technology, and in fact, are necessarily rooted in computer technology. Each of the specific claimed methods and specific claimed systems specifies how computer technology should be manipulated to overcome the problem or problems. The claimed methods and systems enable improving current computer-implemented methods and systems for using automatically machine-collected behavioral data and computer technology for online targeting. Some embodiments of the invention are in the form of an apparatus that is specifically designed to carry out such machine-learning generating of psychometric models, and such predicting of online audiences using the models, so are special purpose machines. The claims therefore are not directed at an abstract idea, and furthermore, the claims do not preclude other methods of predicting psychometric traits or of generating online audiences.

A psychometric trait is called a psychometric dimension herein. By a psychometric profile is meant a set of at least one psychometric dimension, including at least one purely psychometric trait and possibly but not necessarily at least one demographic trait. The dimensions of a psychometric profile of a person are the actual purely psychometric and possibly demographic traits. One aspect of embodiments of the invention is predicting psychometric profiles. A predicted psychometric profile is called a psychometric model herein. Thus, our definition of a set of psychometric dimensions may include (but need not include) at least one dimension that is purely demographic, such as gender, age, income, marital status, ethnicity, and so forth, and our definition of a set of psychometric dimensions does include at least one dimension that is purely psychometric, e.g., that relates to personality, such as openness, conscientiousness, extraversion, agreeableness, neuroticism, measures of intelligence, as well as other measurable psychological attributes of an individual. The definition of demographic as used herein also includes geographical, occupational, educational, and consumer data.

Note that in the literature, the term psychographic profile is sometimes used to describe a person according to such person's psychometric dimensions. Note also that in the Parent Provisional Application, the terms psychographic and psychometric are used interchangeably, so that the term psychographic profile in the Parent Provisional Application is synonymous with the term psychometric model.

Note also that while examples of psychometric dimensions may include sexuality, sexual preference, political preference, illegal substance use, general disregard for the law, and so forth, nothing in this patent description should suggest that embodiments of the present invention are meant to be used to inappropriately discriminate against any individual or group, or for soliciting illegal behavior.

An example implementation provides a method and system for predicting psychometric profiles, i.e., determining psychometric models for each user of an online population of users using automatically-machine-collected data about online behavior of the users. In this disclosure, by a user's behavioral data is meant such automatically-machine-collected data about online behavior of the user. The so predicted psychometric profiles, i.e., the psychometric models, are usable for generating audiences for particular advertisements.

By a method or system “maintaining user anonymity” is meant that the method or system does not need to collect or have access to any Personally Identifiable Information (“PII”) of the user or users, and that any user IDs provided to the system are anonymized. Thus, an aspect of some embodiments of the invention is that the generating of psychometric models from behavioral data can be carried out while maintaining user anonymity, such that the method, apparatus, system, or implementing party does not need to collect or have access to any Personally Identifiable Information (“PII”) of users whose psychometric dimensions are being predicted.

An aspect of some embodiments of the invention is that the method and the system for predicting psychometric profiles are determined using machine-learning based on true rather than predicted psychometric profiles of seed users whose behavioral data also are available. Some embodiments that so determine the method and the system for predicting maintain anonymity of the seed users, such that determining the method or the system for predicting does not need to collect or have access to any Personally Identifiable Information (“PII”) of the seed users.

An aspect of some embodiments of the invention is that the (raw) behavioral data collected on the seed users is obtained by a first entity (called the target population provider herein) that uses a user ID system (of user IDs called target-provider user IDs) which may be different from that of a second entity (called the sample provider herein, with its user IDs called sample-provider user IDs) that provides information to enable the first entity to provide behavioral data on said seed users. The second entity provides access to at least one machine-learning method to seed users or to psychometric data of such seed users without providing the machine-learning method(s) with any PII on the seed users. Any sample-provider user IDs that the second entity provides to the machine-learning method(s) is as anonymized sample-provider user IDs, and further without the first entity having knowledge of the sample-provider user IDs of the seed users.

An aspect of some embodiments of the invention is that the method comprises using a measuring instrument that measures psychometric dimensions on seed users, e.g., by running a psychometric modeling application, e.g., questionnaires in which users enter data, the measured psychometric dimensions comprising purely psychometric measurements and possibly at least one demographic trait of each of the seed users.

An aspect of some embodiments of the invention is that automatically collected data on users is subject to an analysis process in order to summarize features of the automatically collected behavioral data, and thus produces summary behavioral data.

At least one machine-learning method is used with the seed users' summary behavioral data and these users' actual psychometric profiles to determine a machine-implemented method of generating psychometric models of users from the users' machine-collected behavioral data. An aspect of some embodiments of the invention includes applying the determined machine-implemented method to a population of users to generate psychometric models of these users. The number of users in the overall population of users is typically much larger than the number of seed users.

An aspect of some embodiments of the invention is that the seed users' behavioral data, e.g., as summary behavioral data and the seed users' actual psychometric profiles are used to train more than one machine-learning method of generating psychometric models, and that a machine-learning-method selection method is used to select the machine-learning method of generating psychometric models that performs best. In such embodiments, the so-selected method of generating psychometric models is used on the larger population to generate the psychometric models.

The generated psychometric models may be used to predict engagement with a stimulus, such as a particular advertisement, visiting a specific webpage, buying a product on an electronic commerce website, or carrying out other types of digital behavior of interest. Some users are subject to the particular advertisement, and the psychometric profiles of those users who engage, and those who do not engage are used with at least one machine-learning method to determine a method of predicting the likelihood of engagement with the advertisement from a user's psychometric model. In this way, the relative likelihood of engagement can be predicted based as a function of psychometric dimensions, including purely psychometric traits and in some versions, one or more demographic traits. Such relative likelihoods may be used to target particular advertisements to online users based on at least one of the users' psychometric dimensions.

The method of predicting engagement also may be applied to a complete population of users whose psychometric models have been generated, whereby this entire population is ranked in order of likelihood of engagement. The complete population may be segmented into particular audiences according to likelihood of engagement.

Particular embodiments may provide all, some, or none of these aspects, features, or advantages. Particular embodiments may provide one or more other aspects, features, or advantages, one or more of which may be readily apparent to a person skilled in the art from the figures, descriptions, and claims herein.

### Some Embodiments

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the descriptions of embodiments.

### A Networked Computing Environment

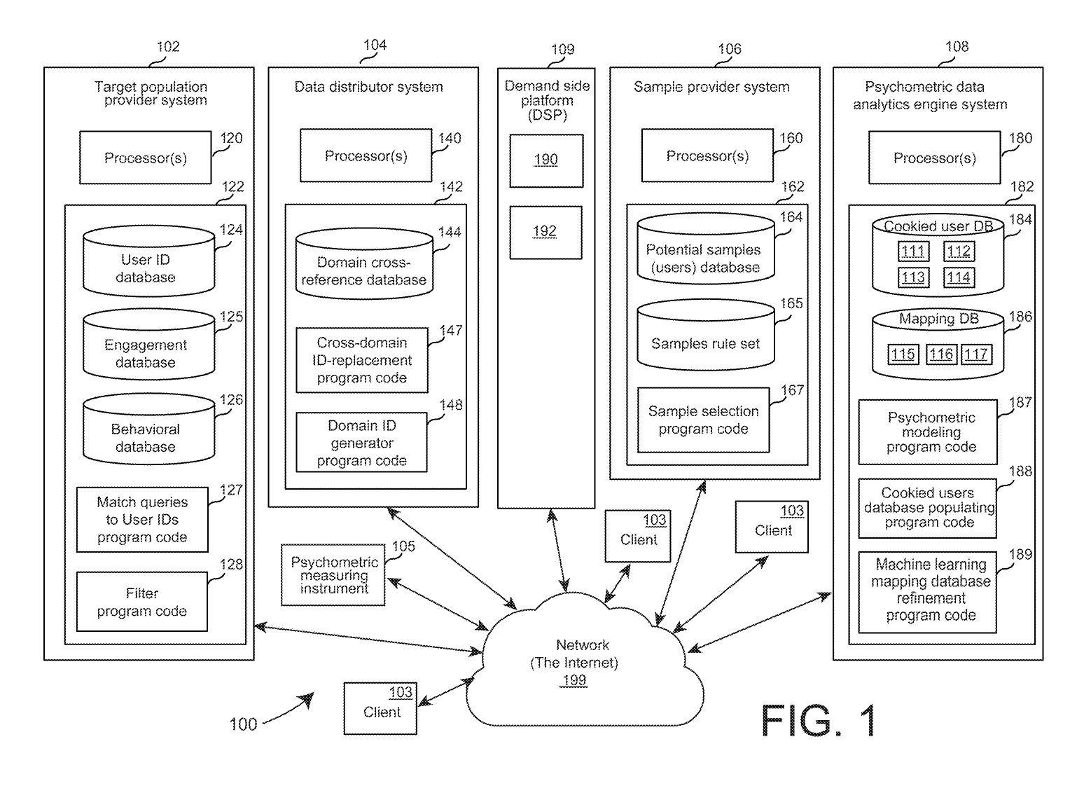

FIG. 1 is an example distributed data processing system 100 in which embodiments of the invention may be implemented and that may include six systems, e.g., server systems each of which may be independently, managed, although alternate arrangements may include at least one of the systems being combined. The systems in distributed system 100 are typically coupled by a network 199, e.g., the Internet, and include a target population provider system 102, a data distributor system 104 for distributing data, for onboarding data and/or for performing ID matching, a sample-provider system 106, and a psychometric data analytics engine system 108. Some embodiments also include a demand-side platform (DSP) system 109 that is separate from the target population system 102. The system 100 may include one or more clients, and three such clients are shown, by way of example, in FIG. 1. An additional system 105 may be included, and this may be similar to one of the client systems 103.

Each system distributed system 100 may include at least one programmable processor (in general, programmable electronic device combined in some embodiments with special purpose hardware) and a storage subsystem, with the storage subsystem comprising RAM and at least one other storage device, the storage subsystem thus comprising a non-transitory computer-readable medium having stored therein program code comprising machine-readable instructions that when executing on at least one of the processors, causes the system to carry out at least one of the methods described herein. A system in distributed system 100 also may be capable of communicating with other system or systems and client computers such as clients 103 and element 105 via the network 199. For the purpose of explaining aspects of the invention, such details as the various interfaces and other elements included in each system are left out of these drawings. Each of systems 102, 104, 106, 108, and 109 may be a specialized computer system accessible to multiple client computers 103 via the network 199. In some embodiments, at least one of the systems 102, 104, 106, 108, and 109 may be a processing system using clustered computers and components that act as a single pool of seamless processing and storage resources when accessed through network 199, as is common in data centers and with cloud-computing resources for cloud-computing applications. In some embodiments, some of the systems, e.g., the psychometric data analytics engine system 108 is configured with special purpose hardware as described hereinunder.

A target population provider is an entity (or a set of entities) that can run online advertising and/or serve at least one application for users, and which has a set or sets of users each with a target-provider user ID that may be different from that of the sample provider (the sample-provider user ID), and which has the ability to automatically collect behavioral data on its users' online activity (including activity on its application, network, or exchange). While in many examples embodiments described herein, behavioral data includes data on websites visited by users, behavioral data may include user-generated text in an application, and/or consumer data, and/or user-preference data, and/or first-party data, and/or web-log data. In embodiments of the present invention, the target population provider provides the overall population of users whose psychometric profiles are to be predicted, and also the behavioral data of such users. The target population provider also provides the behavioral data for the seed users used in training machine-learning methods.

There are several technologies known for automatically collecting behavioral information on users which the users use online technologies, such as browsers and other applications (apps) on their computers and/or mobile devices. Such so-called tracking technologies include using cookies, web beacons, web pixels, device IDs, and so forth. The behavioral information collected includes data on users' current and past online activity, including users' browsing history of websites and web pages visited, engagement behavior on the websites, search queries, and in-application behavior. Such collected behavioral data are commonly used as inputs for machine-implemented methods (algorithms) for targeting specific groups of individuals to receive content, and such machine-implemented methods are commonly used to serve online advertising content (electronic advertising) designed for specific groups to the specific groups of individuals.

Examples of a target population provider and of such a population of users include, but are not limited to, the set of users (and target-provider user IDs) of an application such as a mobile app, the set of users (and target-provider user IDs) of an online data platform, the set of users (and target-provider user IDs) of an “Internet of Things” (“IoT”) device, the set of users (and target-provider user IDs) of a digital media channel (or of a network of digital media), the set of users (and target-provider user IDs) of an online advertising platform, such as an advertising network, a supply side platform target population provider (“SSP”), a demand side platform target population provider (“DSP”), or a data management platform (“DMP”), each of which could comprise computers, communications and other processing resources. Therefore the population of users of the general term “target population provider” may refer to other types of online user populations besides advertising providers, such as online users of applications like Twitter®, Facebook®, and so forth, users of large publishers like Reddit®, users of mobile apps, and so forth.

The target population provider in some embodiments of the invention is provided by target population provider system 102 that includes at least one processor 120 and a storage subsystem 122, and might be used in an advertising network, an SSP, a DSP, or a DMP. Instead of, or in addition to, target population provider system 102, another system might be used as a substitute, or in addition to, system 102, e.g., as a DSP, and/or e.g., for other online populations outside of advertising technology, including but not limited to digital populations of mobile applications, desktop applications, “Internet of Things” (IoT) devices, virtual reality (VR) and augmented reality (AR) devices, digital media platforms, payment platforms, and so forth.

The storage subsystem 122 of target population provider system 102 comprises a user ID database (DB) 124 comprising target-provider user IDs of users, an engagement database 125 of users who engage with a pre-defined stimulus such as an advertisement, and a behavioral database 126 of behavioral data of users. Storage subsystem 122 additionally has program code that, for purposes of explanation, is shown as ID-matching program code 127 and filter program code 128.

In one embodiment, user ID database 124 maintains a record for each user of the target population provider system 102. Such a record for a user may or may not include personally identifiable information (PII), such as an email address or actual name for that user. The user record also may include URLs visited online by the user, and other click-stream activity for that user, and further may include cookies or other anonymous IDs provided for or to the user that identify the user. By a click-stream is meant a series of mouse clicks or other selections made while a user is at a website or is linking to multiple websites. A website in this context includes screens of mobile applications used by the user, messages on social platforms such as Twitter, Facebook, and so forth, programs viewed on a smart (network connected) TV, and so forth.

The User ID database 124 typically includes records for a large number of users, for example, for hundreds of millions of users, or even billions of users.

Engagement database 125 contains records used by the target population provider system 102 for information on users' interactions with at least one particular stimulus. e.g., a particular element on at least one (online) advertisement. For example, engagement database includes data collected by an advertising provider, such as system 102, using users' interactions with particular advertisements, possibly other attention metrics on users' interactions with publishers' or advertisers' content, and possibly consumer data. While in one embodiment, the engagement database is a separate data structure from the user ID database 124, in alternate embodiments, the engagement data may be provided as additional fields in user records in the user ID database 124.

Behavioral database 126 contains historical logs of behavioral data on users. In this example implementation, these behavioral data include web domains visited, full page-view URLs, timestamps, and geo-location data, among other items of data; in other implementations, the behavioral data may include user-generated text, e.g., posts made on blogs, on social media such as Twitter®, Reddit®, or Facebook®, or spoken-language data, or user-preference data, including but not limited to merchant-level purchase data. In general, behavioral data for a user comprises data on a user's past behavior.

In some embodiments, the behavioral data in behavioral database 126 may be in raw form. An analysis method is used to reduce dimensionality of the data to summary form. Details of how the analysis method to convert such behavioral data to summary behavioral data usable for carrying out aspects of the present invention is described in more detail herein below. While the analysis method described herein below in detail is for textual analysis of websites visited by users, behavioral data may include or instead be comprised of one or more of text messages, emails, blogs produced (or read), data documents, text files, database files, log files, transaction records, purchase orders, and so forth.

While in one embodiment, the behavioral database 126 is a separate data structure from the user ID database 124, in alternate embodiments, the behavioral data on any user may be provided as additional fields in user records in the user ID database 124.

Match queries to user IDs program code 127 is operative to allow the target population provider system 102 to accept an input request listing at least one user, e.g., identified by the user's unique target-provider user ID or by at least one cookie, and to determine the user records of user ID database 124 that match at least one user specified in the input request.

Filter program code 128 is operative to filter user records in user ID database 124, for example to exclude or flag those users that meet some pre-determined criteria, e.g., those users that have a relatively low amount behavioral data in the behavioral database 126. In one example, any target-provider user ID that has less than an operator-settable or pre-defined threshold amount of behavioral data is filtered out. In one embodiment, the threshold is ten behavioral data points per user.

In another version, the filter program code 128 is operative to provide behavioral data on a settable number of those users that have the most behavioral data in behavioral database 126.

In one implementation, only behavioral data on filtered target-provider user IDs (i.e., those have at least the threshold amount of behavioral data) are received to ensure that only behavioral data on users that have sufficient amounts of behavioral data associated with them over a given time period are used for modeling using machine-learning, as described in detail hereinunder. Example time periods might be three months, six months, or something in between or outside of those time periods.

As described in more detail hereinunder, the behavioral data of users having those filtered IDs may be joined and processed (in a separate system from the target population provider system 102) with those users' actual psychometric profiles of psychometric dimensions (optionally including demographic traits). The demographic data is collected by a measuring instrument, e.g., by, for example, having those users answer a set of questions via, e.g., the users being directed to an application that provides questions and accepts answers. FIG. 1 shows the psychometric measuring instrument as a separate element 105 coupled via the network 199. In one embodiment, psychometric measuring instrument 105 may be a client system comprising at least one processor and a storage subsystem (these elements not shown), the storage subsystem comprising code, e.g., code loaded into the system 105 via the network that when executed causes said application to operate to provide questions and receive answers from a user, e.g., via a user interface included in system 105.

Thus, the system 100 provides for a set of individuals, called seed users, both psychometric profiles and behavioral data. While the behavioral data is maintained in the target population provider system 102, as will be described herein below, the seed users may be provided by at least one system separate from the target population provider system 102, and the psychometric profiles of those seed users also may be provided by a separate system. The seed users' psychometric profile data and corresponding behavioral data, e.g., as summary behavioral data are used as seed data for at least one machine-learning method to determine a method of predicting a psychometric profile of a person from that person's behavioral data, even when no or little psychometric data is a-priori available for that person.

Note that the data of users in the target population provider system 102 may be identified by a target-provider user ID, or by such a person's cookie.

A sample provider is an entity that can provide sample users, for example, in order to use the measurement instrument on those users to measure traits of those users, e.g., by having those users provide psychometric profiles. The so measured psychometric profiles of those users can be used with automatically machine-collected behavioral data on the same users in order to train the machine-learning methods described hereinunder to predict psychometric profiles, i.e., to determine psychometric models. The functionality of the sample provider is provided in one embodiment by the sample provider system 106 that comprise at least one processor 160 and a storage subsystem 162 that includes a database 164 of users (called panelists) that may be potential providers of psychometric profiles, and a samples rule-set database 165 that provides rules defining how the sample provider system 106 can sample its user database 164, and might also include sample selection program code 167 that uses the samples rule set 165 to sample records from the larger database 164 of sample provider users to form a set of sample users that are to be used as the seed users from whom to obtain psychometric profiles. In some embodiments, the database 164 of users (panelists) includes cookies or other user IDs, and additional information such as demographic information (that, as defined herein, may include geographic and/or consumer information) on the panelists.

For example, the sample selection program code 167 may be operative to cause user database 164 to be sampled using data derived from cookies, including demographic information (including geographic and/or consumer information), which may be used to derive samples of users to form the seed users that satisfy one or more criteria. As an example, it may be desired to provide samples of users that are balanced to ensure a representative cross-section of the population being sampled, by using data on users such as region, age, gender, race, ethnicity, income, education, etc. In other cases, it may be desired to provide nested samples of users that are balanced in some demographic dimensions, but that satisfy other demographic criteria, e.g., that are from particular professions, or that have particular ranges of incomes.

Users in the user database 164 of the sample provider system 106 may be uniquely identified by a sample-provider user ID. The sample provider system thus forms another domain in which users are identified by a domain-specific user ID—the sample-provider user ID—that typically is different than the target-provider user ID.

A data distributor is an entity that can carry out matching of user IDs in the ID system of the sample provider with user IDs in the ID system of the target population provider system 102. Thia may be carried out, for example, by cookie matching or some other method. The data distributor also can carry out translating (also called matching or transforming) of user IDs in one ID system to use IDs in the second ID system. In some embodiments, at all times, both the sample provider system 106 and the target population provider system 102 can access lists of users only in terms of their own respective ID system. In this case, it is only via the data distributor that a user ID in one ID system can be matched to the same user's user ID in the other ID system.

In some embodiments, the functions of the data distributor are provided by the data distributor system 104 that includes at least one processor 140 and a storage subsystem 142 that maintains a domain cross-reference database 144 and that has program code including domain ID replacement program code 147, and domain ID generation program code 148. Records in database 144 are used for cross-referencing, with each record containing a mapping between an identifier in a first domain, e.g., the sample provider domain, to an identifier in a second domain, e.g., the target population provider's domain. As an example, the first domain might use unique user identifiers that can be linked to PII on those users in its databases, whereas the second domain, e.g., the target population provider system 102's domain operates on additional behavioral data about those users, but the unique identifiers from the second domain cannot be linked to any PII on those users within the target population provider system's database. In some instances, such as where a database manager in a first domain first passes its data to data distributor system 104 for matching with a second domain, the domain cross-reference database 144 matches domain-one IDs with their users' corresponding domain-two IDs and then cross-domain ID-replacement code 147 replaces domain-one IDs with domain-two IDs, which it then passes to the domain-two systems. This allows the data recipient in the second domain to operate on only their own user IDs without having access to the unique identifiers of the first domain or to the unique identifiers used by data distributor system 104.

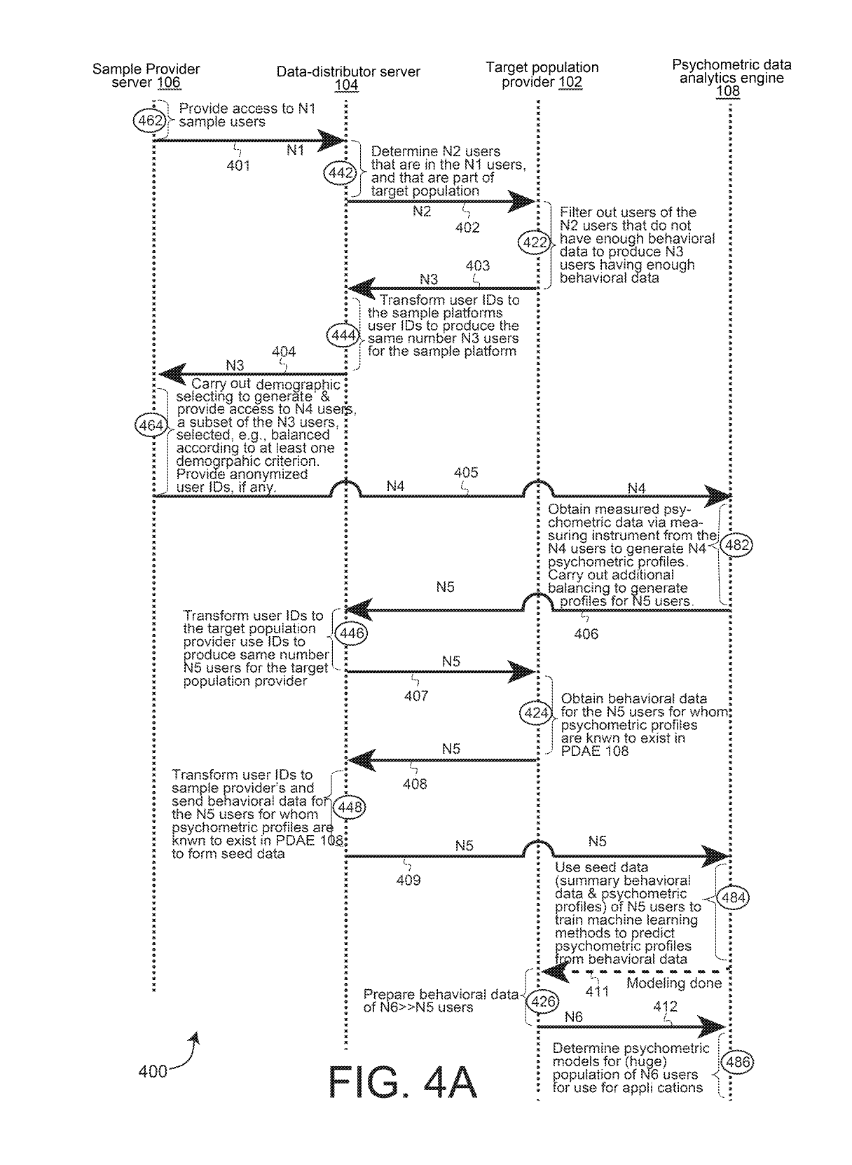

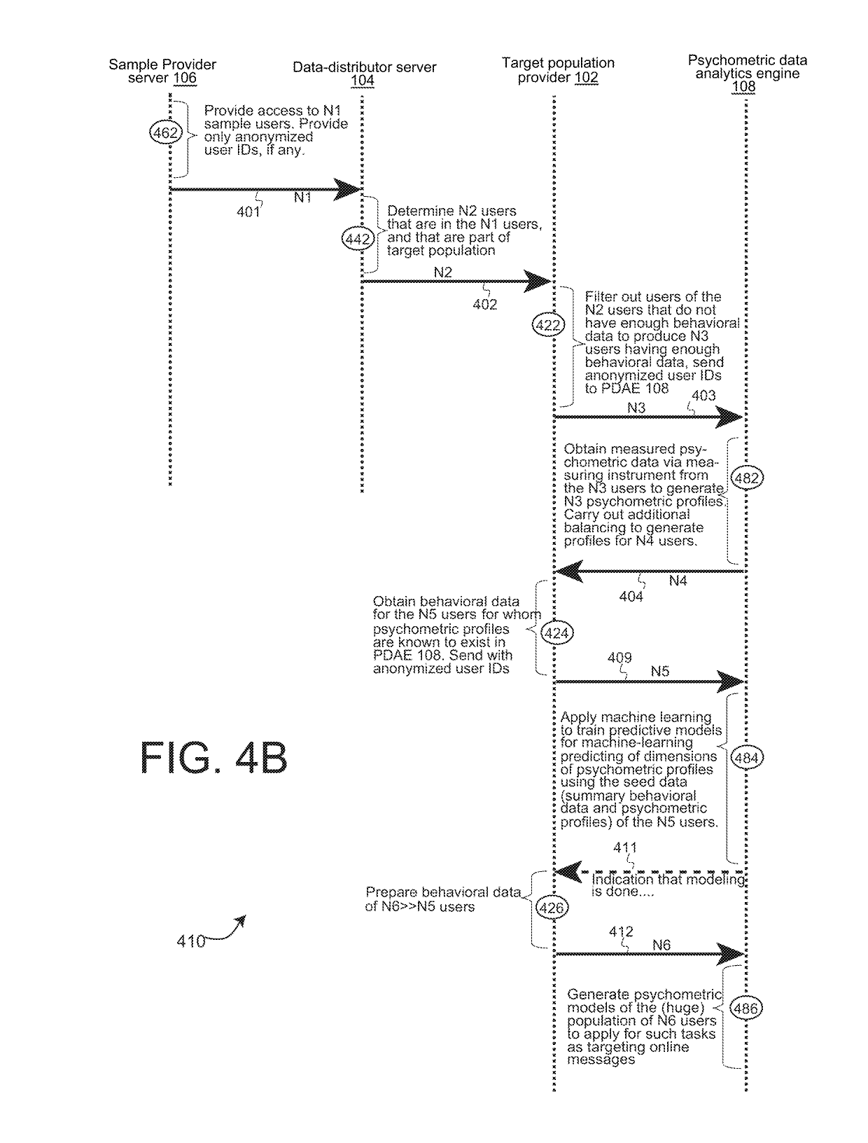

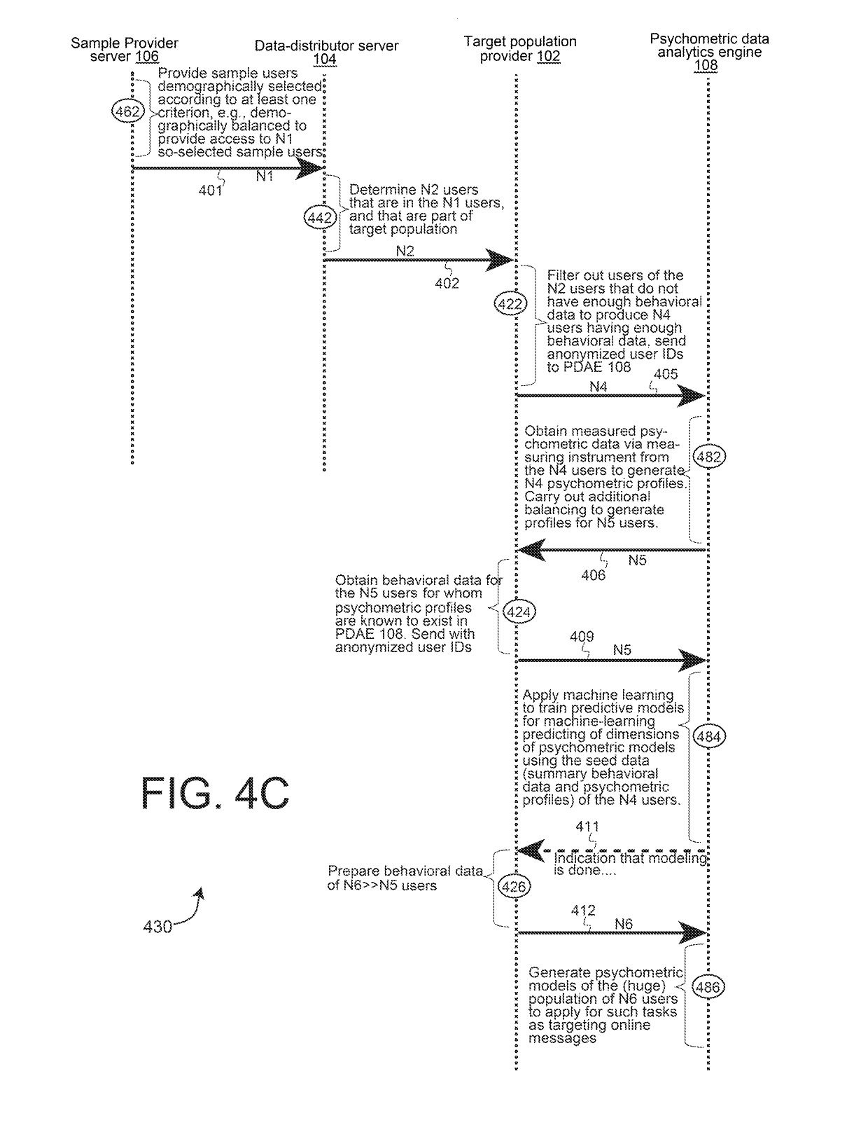

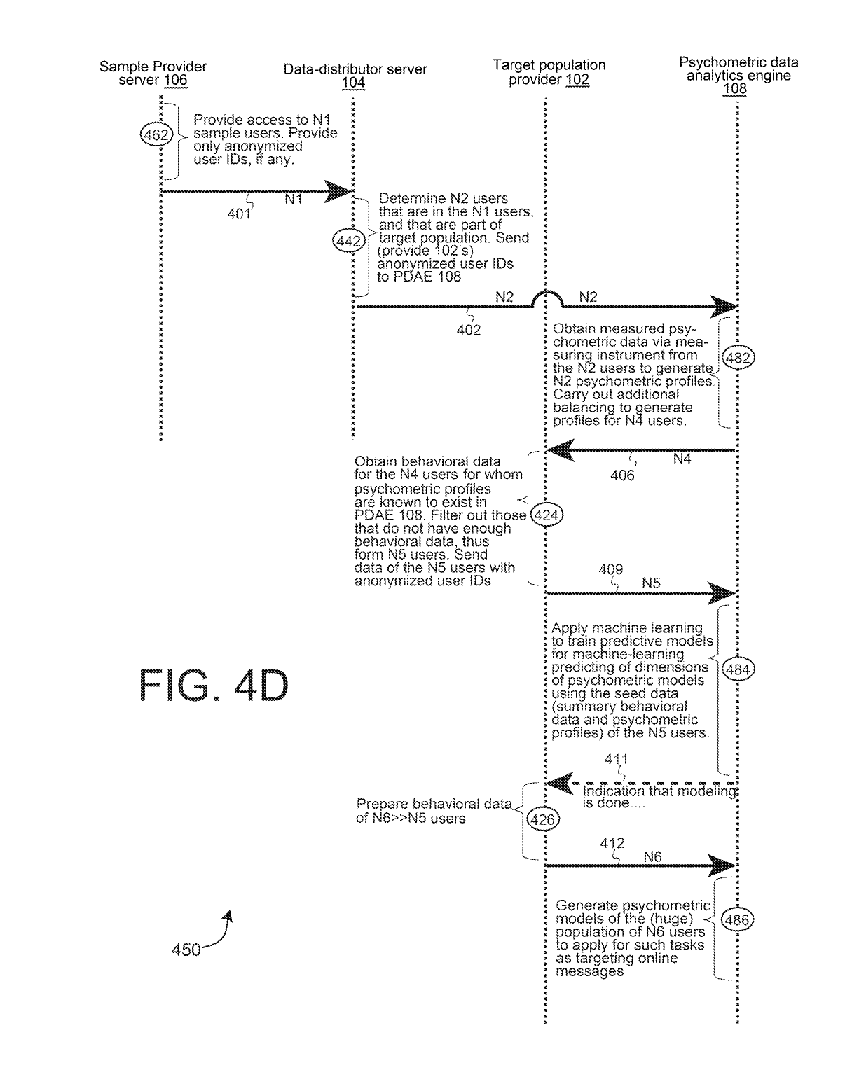

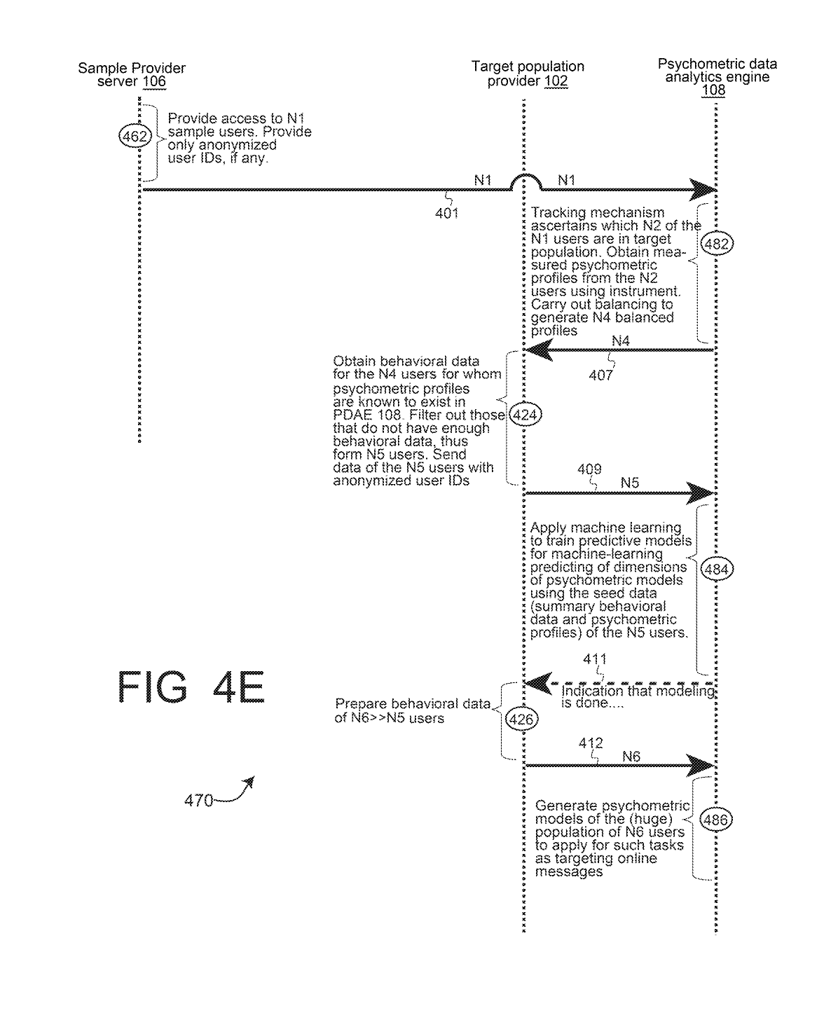

In more specific terms relevant to the example data flows shown in FIGS. 4A-4E and described in more detail below, target population provider system 102 and sample provider system 106 each have their own anonymized systems of IDs. Neither system needs share its own ID with the other's ID and preferably does not do so. Rather, the sample provider system 106's list of IDs passes through data distributor system 104, which replaces the list of their users' IDs with the same users' corresponding IDs on target population provider system 102. The reverse happens when data flows in the opposite direction.

A psychometric modeling entity as used herein is the entity that runs the psychometric-modeling methods described herein. The psychometric-modeling entity maintains the psychometric models of users (as well as the measured psychometric profiles of the users, e.g., provided by the sample provider). One aspect of embodiments of the invention is that the psychometric-modeling entity is not able to identify the users, e.g., using personally identifiable information (PII).

Furthermore, in some embodiments the psychometric-modeling entity has no knowledge of actual user IDs in either the ID system of the sample population provider or that of the target population provider. The sample population provider can only send anonymized or hashed rather than true sample-provider user IDs to the psychometric modeling entity. Similarly, the target population provider can only send anonymized or hashed rather than true target-provider user IDs to the psychometric modeling entity.

One aspect of embodiments of the invention is that the psychometric modeling entity may receive behavioral data for a set of users, called a set of seed users, and also obtain psychometric profiles for the same set of seed users (by using the measuring instrument, e.g., element 105 on the seed users to provide the measured psychometric dimensions of their profiles), without needing to have access to any PII on these users. The behavioral data may be analyzed to produce summary behavioral data. The seed users' (summary) behavioral data and psychometric profiles are used to train one or more machine-learning methods to determine a method of predicting a user's (unknown) psychometric profile from the user's behavioral data. Another aspect of the invention is that the psychometric-modeling entity may receive from the target population provider behavioral data on users whose full psychometric profiles are not known, and use the determined method of predicting to predict psychometric profiles for the users whose behavioral data is received (and in some embodiments, analyzed into summary behavioral data). Another aspect of the invention is that engagement data may be provided to the psychometric modeling entity, the engagement data indicative of the likelihood of users whose psychometric models are known to the psychometric-modeling entity engaging with a particular stimulus, e.g., a particular advertisement or webpage. The psychometric-modeling entity may use at least one machine-learning method to determine a method of predicting relative likelihoods of engagement with the particular stimulus based on a user's psychometric model. The psychometric-modeling entity may use the method of predicting relative likelihoods of engagement on all users for whom psychometric models are available to partition said all users according to the relative likelihood of engagement, thus determining audiences for the particular online stimulus.

In some embodiments of the invention, the functionality of the psychometric modeling entity are provided by a psychometrics data analytics engine (PDAE) 108 (also called the psychometrics data analytics system) that comprises at least one processor 180 and a storage subsystem 182 that may include memory and at least one other storage device, and thus comprising a non-transitory computer-readable medium that stores a user database (cookied user DB) 184 of users who are typically cookied, or who may also be anonymously identified through a device ID, so that tracking information may be available for the users, a mapping database (mapping DB) 186, program code 187 for running the psychometric profile modeling and predicting methods described herein, program code 188 for populating user DB 184 with psychometric models of the users by applying the models generated as described herein, and program code 189 for carrying out the machine-learning methods described herein to predict using machine-learning data indicative of engagement with at least one particular stimulus, e.g., an advertisement and further to refine mapping database 186 that includes engagement data and audiences for the particular stimulus.

PDAE 108's user DB 184 comprises records for many users. In one embodiment, the users in database 184 may be categorized as two sets of users, the seed users and other users called inferential users. The records in database 184 of seed users comprise records, perhaps thousands of records, with anonymized sample-provider and/or anonymized target-provider user IDs, each seed user having behavioral data that was automatically collected by the target population provider to form summary behavioral data 111 and also psychometric data (a psychometric profile) 112 that was collected for the seed user by the measuring instrument, e.g., element 105 that, for example, causes the seed user to manually enter data via a questionnaire or a psychometric-modeling application. The portion of database 184 for inferential users may include millions, even hundreds of millions, or even billions of records, with anonymized target-provider user IDs, each user having behavioral data from the target population provider system 102 associated therewith, as summary behavioral data 113. As explained herein, PDAE 108 would use its processes to learn methods of predicting profiles, the learning using the data of seed users, and then use the prediction methods on the inferential users which use each inferential user's behavioral data 113 to generate a psychometric model of psychometric dimensions (including at least one demographic trait) for the inferential user, so that psychometric models 114 for the inferential users' IDs are determined in database 184.

In some implementations, the two sets of users (seed and inferential) are parts of one database 184 with records having flags to indicate whether a user is a seed user or an inferential user. In other embodiments, the database 184 includes two separate databases: a seed-user database and an inferential-user database.

Some implementations include code in the storage subsystem 182, e.g., as part of code 187 that causes at least one of the processors to carry out an analysis process that summarizes the automatically collected behavioral data, and thus produces summary behavioral data. The summary behavioral data may be stored in cookied user database 184.

Database 184 includes records that match psychometric dimensions (including at least one demographic trait) to behavioral data. Initially, during a machine-learning stage using seed user data, the psychometric dimension data 111 comes from gathering direct psychometric data for the seed users via the measuring instrument, e.g., data of several thousand users who are representative of the total population of users in that system. The psychometric data of the seed users may be matched with the seed users' corresponding behavioral data that was automatically machine-collected and provided by the target population provider system 102, then summarized into summary behavioral data 112 for the seed users.

Program code 188 later populates the cookied user DB 184 with models 114 wherein most users are inferential users who do not have directly collected psychometric data associated with them, the populating using summary behavioral data 113 of the inferential users.

Thus, in one aspect of the invention, machine-learning is used to train prediction methods, the training using the seed users' data 111 and 112 to learn prediction methods that predict psychometric dimensions (including demographic trait(s)) from behavioral data. Another aspect of some embodiment is to select the prediction method that achieved the best performance on some seed data according to a selection criterion. Another aspect is to use the learned (and selected) prediction method (by activating program code 188) to determine psychometric models of psychometric dimensions (including demographic traits) for inferential users.

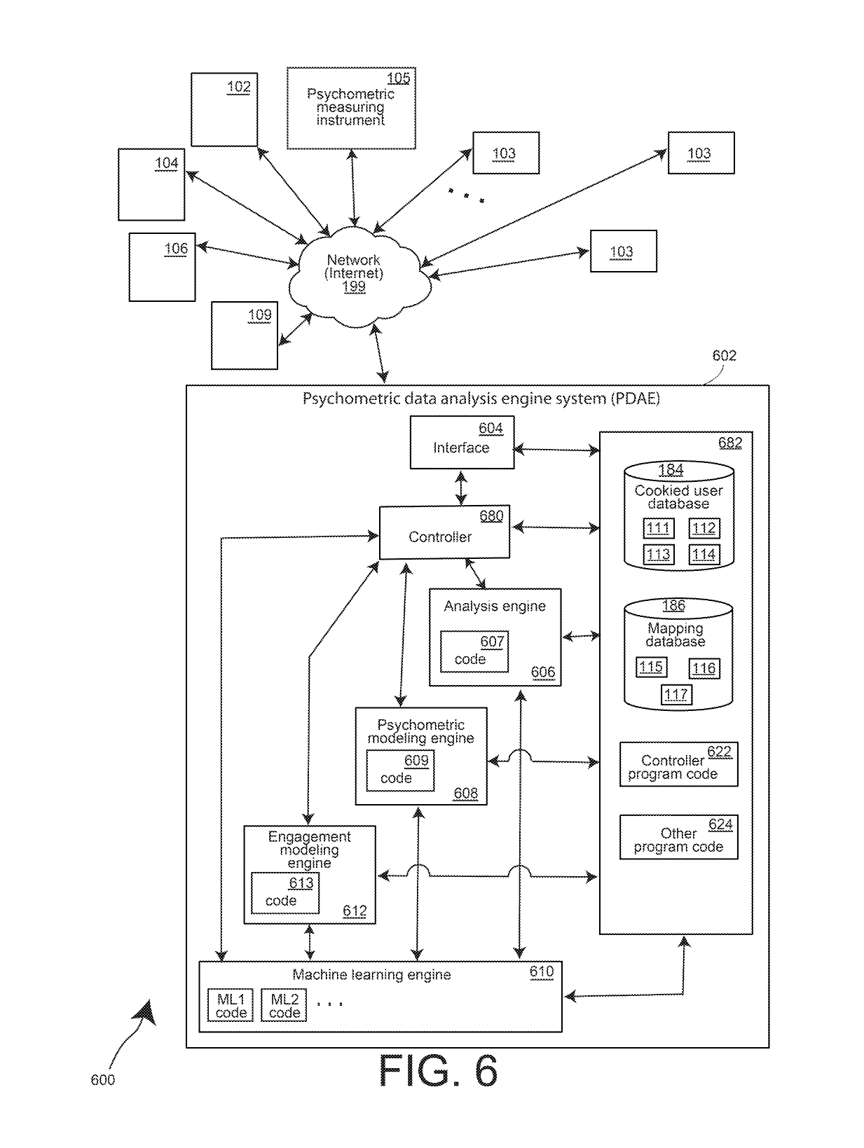

While FIG. 1 shows PDAE 108 as comprising at least one processor 180 and a storage subsystem 182, such processor(s) with relevant program code may be replaced or augmented in some embodiments by special purpose hardware that is specifically configured to carry out the some of the specific processes described herein. See FIG. 6 its description below for more details on such a system.

In some embodiments, system 100 also includes another entity called a demand-side platform (DSP) system 109 that includes at least one processor 190 and a storage subsystem 192. The DSP 109 provides for buyers of digital advertising a mechanism to manage advertising exchange and data exchange accounts through a single interface. Such exchanges allow for real-time bidding for displaying online advertising. The DSP is used in some embodiments of the invention to provide an advertisement to the target population provider system 102, so that the target population provider can allow the advertisement to be displayed to (at least some) of its users on its media inventory (or on the media inventory of a third-party publisher, publisher network, or SSP). Another aspect of some embodiments of the invention includes the target population provider system 102 automatically machine-collecting actual engagement data captured for a particular advertisement of users who do (and on users who fail to) engage with the particular advertisement. The set of client systems 103 (operating with the population provider system 102) thus may form an engagement measuring instrument that collects and may provide to PDAE 108 engagement data from users for the particular advertisement. Another aspect is the target population provider system 102 passing the engagement data to PDAE 108, and PDAE 108 accepting the engagement data. This data is maintained in some embodiments in mapping database 186 as data 115. PDAE 108 would have psychometric models (in 114) for at least some of the users whose engagement data PDAE 108 receives. Hardware and code in PDAE 108 (in code 189) uses the engagement data 115 and the psychometric models in 114 of those users whose engagement data for a particular stimulus (the advertisement) is known, to rank the users according to the likelihood of engagement with the advertisement based on their psychometric models. This combination of likelihood of engagement with the particular advertisement with the psychometric models may be used by methods in PDAE 108 to learn, using at least one machine-learning method, a method of predicting the likelihood of users' engaging with the advertisement based on their respective psychometric models to form an engagement model 116. Once the engagement-prediction method is available, such a method may be used on the overall population whose psychometric models are available or can be determined to generate audiences 117 of users whose likelihood to engage falls into one or another of a set of ranges. Such audiences may then be sent by PDAE 108 to the target population provider system 102. The target population provider system 102 may then send the audiences to DSP system 109, which then can provide advertisers or their agencies with the ability to execute advertisement purchases against custom psychometric audiences whose members include users of the target population provider system 102.

Thus, mapping database 186 receives additional data about users according to such users' responses to at least one particular stimulus, such as an online advertisement. Reactions (as well as non-reactions) to such a stimulus are called “engagement data” herein. Such engagement data may include time spent on different parts of a web page, as well as interacting with a particular advertisement, as well as click-through rates and conversions (such as direct response or app installs or purchases). Program code 189 cause PDAE 108 to carry out machine-learning to predict likelihood of engagement to the at least one particular stimulus. Program code 189 in some embodiments further carries out partitioning of a provided population according to likelihood of engagement with the at least one particular stimulus. Such data is stored and updated in mapping database 186.

Note that not all embodiments of the invention use all the entities shown in FIG. 1. For example, some embodiments incorporate at least some of the elements of the DSP 109 into the target population provider system 102. Furthermore, some alternate embodiments include yet another entity, similar to the data distributor system 104 that is able to translate target-provider user IDs into user IDs in the ID system of the DSP 109. Furthermore, some embodiments do not use data distributor system 104. Furthermore, some embodiments include the separate measuring instrument 105 to obtain and provide the psychometric profiles of seed users.

### A Method Embodiment

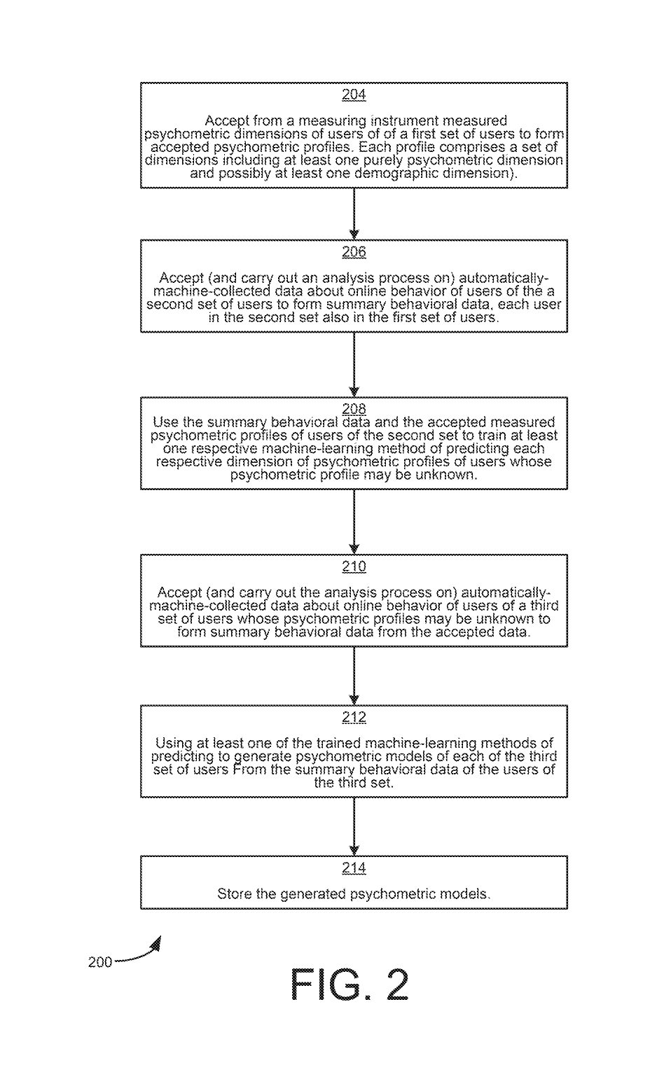

FIG. 2 shows a simplified flow chart of an embodiment of a method 200 of operating a machine to predict psychometric profiles of online users. The method, for example, is carried out in PDAE 108, and includes in 204 accepting from a measuring instrument (e.g., element 105) measured psychometric dimensions of users of a first set of users to form accepted psychometric profiles of users of the first set. The measuring instrument, for example, carries out measurement by data entry by the users of the first set. Each psychometric profile (whether predicted as a model, or measured from the instrument) comprises a set of dimensions including at least one purely psychometric dimension and optionally at least one demographic dimension, the accepted psychometric profile of each of the users of the first set measured from each user of the first set, e.g., by sending the user to the instrument that displays a website or application that requires data entry, while maintaining the anonymity of the user. The accepted psychometric profile of each user of the first set may be obtained by data entry by said each user of the first set. The method further comprises in 206 accepting automatically-machine-collected data about online behavior of users of a second set of users. This includes forming summary behavioral data of the second set users. As described in more detail hereinunder, each user of the second set is also in the first set, such that the method has for each user of the second set, both the accepted measured psychometric profile and the accepted automatically-machine-collected data about online behavior of the user. In some embodiments, the method includes carrying out an analysis process on the accepted automatically-machine-collected data about online behavior to form the summary behavioral data. The method comprises in 208 using the summary behavioral data and the accepted measured psychometric profiles of the users of the second set to train at least one respective machine-learning method of predicting each respective dimension of psychometric profiles of users whose psychometric profiles may be unknown, thus generating psychometric models of the users whose psychometric profiles may be unknown, but whose summary behavioral data is known. Each so-trained respective machine-learning method of predicting the respective dimension for a user whose psychometric profile may be unknown uses the summary behavioral data of the user whose psychometric profile may be unknown. The method further comprises in 210 accepting (and possibly carrying out the analysis process on) automatically-machine-collected data about online behavior of users of a third set of users whose psychometric profiles may be unknown to form summary behavioral data of the users of the third set; and in 212 using at least one of the trained machine-learning methods of predicting to generate psychometric models of each of the third set of users from the summary data of the users of the third set. The method may include in 214 storing the generated psychometric profiles (the psychometric models), e.g., in a database. One feature is that the method is able to maintain the anonymity of each of the users of the first set, each of the users of the second set, and each of the users of the third set, for example by any user ID in the machine of a user of the first, second, or third set being an anonymized user IDs of the user.

Different embodiments differ on how the first set and second set of users are selected. In some embodiments, access to the users of the first set, e.g., by directing such users to the instrument, e.g., to a website or application and/or by providing the anonymized user IDs of the users of the first set, is provided by the sample provider system 106. In some versions, the sample provider system may have some demographic information on its users, and the users of the first set may have undergone selecting according to at least one demographic criterion. One example criterion is to demographically balance users. Another is to be selective in one or more demographic categories, e.g. consumer categories, may include, but are not limited to, business-to-business categories such as professional position, in-market segments such as people about to buy a home, automobile ownership categories, and so forth.

In some embodiments, the automatically machine-collected data about online behavior of users of the second set are provided by the target population provider system 102, and thus these users have target-population user IDs. These users also have sample-provider user IDs, since users in the second set are also in the first set of users.

In some embodiments, only users that are determined to have enough behavioral data are included in the second set. In some such embodiments, the second set of users is selected after filtering out those users of the first set who do not have enough behavioral data.

In some embodiments, the first set of users is a set of users selected to have psychometric profiles that are balanced, the selecting being from a set of users whose psychometric profiles have been collected.

In some embodiments, the second set of users are of a set of users to whom access is provided by the sample provider, and who are determined to also be part of the target population of the target population provider system 102. In some such embodiments, prior to behavioral data being made available to the method, users of the target population that do not have enough behavioral data are filtered out. In one such embodiment in which the sample provider system carries out some demographic selection of the users of the second set according to at least one demographic criterion, e.g., to demographically balance the sample, or, e.g., to select one or more traits, the demographic selecting is carried out on users after other users who do not have enough behavioral data have been filtered out. In one such embodiment, the accepting of the automatically-machine-collected data about online behavior occurs after the accepting of the psychometric models of users of the first set and after said demographic selecting.

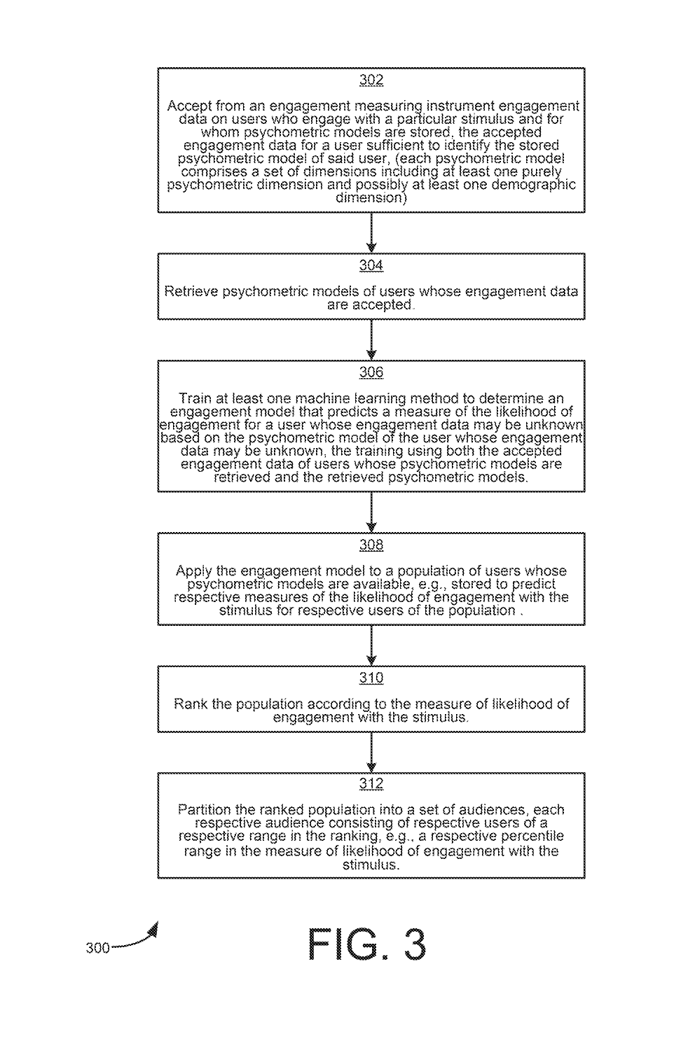

FIG. 3 shows a simplified flow chart of an embodiment of a method 300 of operating a machine to determine a model that predicts the likelihood of engagement with a particular stimulus such as an advertisement by respective online users as a function of respective psychometric models of the respective users. The method, for example, is carried out in PDAE 108 wherein psychometric models of users are stored, and includes in 302 accepting from an engagement measuring instrument, e.g., clients 103 (with system 102) engagement data on users who engage with (and in some versions, on those who do not engage with) the particular stimulus and for whom psychometric models are stored. The engagement data accepted for a user is, e.g., sufficient to identify the stored psychometric model of said user. The psychometric models can be, for example, those generated using the method 200 described in the flow chart of FIG. 2. The engagement measuring instrument may be that shown as 105 in FIG. 1, and for example may include client systems 103 that are caused to display to users a website that includes a tracking mechanism of the particular stimulus. The method further comprises in 304 retrieving stored psychometric models of users whose engagement data are accepted (and whose accepted data are sufficient data to identify the psychometric models of the users), and in 306 training at least one machine-learning method to determine an engagement model that predicts a measure of the likelihood of engagement for a user whose engagement data may be unknown based on the psychometric model of the user whose engagement data may be unknown. The training uses both accepted engagement data on the users whose psychometric models are retrieved, and the retrieved psychometric models. This engagement model is useful for understanding the relative odds of engagement for any particular psychometric dimension while maintaining all other dimensions constant.

Some embodiments of the method further include in 308 applying the engagement model to a population of users whose psychometric models are available, e.g., stored in PDAE 108, to predict respective measures of the likelihood of engagement with the particular stimulus for respective users of the population of likelihood of engagement with the particular stimulus.

In some versions, in 310, the population is ranked according to the measure of likelihood of engagement, and in 312, the ranked population is partitioned into a set of audiences, each respective audience consisting of respective users of a respective range in the ranking, e.g., a respective percentile range of likelihood of engagement. For example, one audience can be the top five percent of users in measure of likelihood to engage.

Different embodiments differ on how the engagement-measuring instrument provides the set of users' engagement data. Some methods of engagement tracking may use pixels, tags, tag-management systems, or other existing website infrastructure, or third-party attention-metric services, or the collection of device IDs within an application. Different embodiments also differ on which population the engagement model is applied to.

In different embodiments, applying the engagement model may be to carry out at least one of the set of actions consisting of (a) applying the engagement model to carry out targeting the particular stimulus to users having at least one particular psychometric dimension, (b) comparing the engagement model for the particular stimulus to at least one engagement model for at least one other particular stimulus to select a stimulus for online presentation, and (c) applying the engagement model to a population of users to predict the likelihood of engagement with the preparing stimulus.

These different embodiments are described in more detail below as data flows and processes, and as a special purpose hardware system.

### Data Flows and Processes

FIG. 4A shows a representation 400 of the data flow between the four systems 102, 104, 106, and 109 of FIG. 1, and of the data processing carried out as processes in each of the systems with each type of data, according to one embodiment of the invention. Note that systems 102, 104, 106, and 109 are called “servers” in the drawing. Processes carried out in the target population provider system 102 are shown having a reference numeral with middle digit 2, processes carried out in the data distributor system 104 are shown having a reference numeral with middle digit 4, processes carried out in sample provider 106 are shown having a reference numeral with middle digit 6, and processes carried out in or managed by the psychometric data analytics engine 108 (“PDAE 108”) are shown having a reference numeral with middle digit 8.

In some embodiments, sample provider system 106 in process 462 provides access to a number N1 of (anonymized) users and sends access to these, e.g., as sample-provider user IDs in data block 401 to data distributor system 104. Data block 401 comprises records of such users (called panelists). N1, for example, could be in the order of 500,000 records or even more than one million records. These panelists typically would be cookied and have anonymized sample-provider user IDs.

The data distributor system 104 receives the N1 records of data block 401 and in process 442 matches the sample-provider user IDs to corresponding target-provider user IDs. Typically, only some, say a number N2, of the users of data block 401 have overlapping user IDs in the target population provider system 102. These N2 overlapping users form users of a data block 402. The data distributor system 104 sends data block 402 of the N2 users, using the target-provider user IDs to the target population provider system 102.

Target population provider system 102 includes a database of behavioral data for all users of the target population provider system 102, such users called the “target population.” herein. Some of the N2 users of data block 402 may not have much behavioral data associated with them in the target population provider (or may otherwise be not valid). In a process 422, the target population provider system 102 filters out the users of data block 402 that have less behavioral data than some predetermined threshold, e.g., less behavioral data logged over some pre-defined, or settable time period, or relatively less than the other users in the population to form data block 403 comprising N3 records from user database 124 that not only overlap with the N1 panelists of data block 401 from the sample provider system 106, but that also pass the behavioral-data filter of process 422. In one embodiment, the threshold is 10 behavioral data points. In another all but the 100,000 users with the greatest amount of behavioral data may be filtered out. These records identify users by using the target-provider user ID system, and in one version, are identified by a user ID data string. Such a user data string, in embodiments that use alphanumeric characters, might appear as a string like “AQstovpcyv84xJ2SZRi7o4lg.” Of course, many user ID schemes can be used in alternate embodiments.

Note that some alternative embodiments omit the step of filtering out of low-behavioral-data IDs.

Target population provider system 102 sends data block 403 of N3 users to data distributor system 104, which in process 444 matches these IDs to their corresponding IDs in the ID system of sample provider system 106 and thus forms data block 404 of these N3 records in which users are identified by sample-provider user IDs.

The data distributor system 104 sends data 404 to sample provider system 106. Note that by having the data distributor as an intermediary, the target population provider system 102 can provide sample provider system 106 with information about the N3 users listed in data block 403 without providing the sample provider system 106 the ability to know the target-provider user IDs of the users of data block 403.

Recall that in some embodiments, sample provider system 106 has demographic and other information on its panelists' user IDs. In some embodiments, the sample provider system 106 in process 464 carries out demographic selecting of the N3 users of data block 104 according to at least one demographic criterion to generate a data block 405 of N4 demographically selected users, these N4 users being a subset of the N3 users of data block 404. One example of such demographic selecting is to generate demographically balanced users, e.g., geographically balanced users. Another example of such demographic selecting is to generate users who have one or more pre-defined traits of interest, and which are otherwise demographically balanced, for example, lawyers who are otherwise demographically balanced. This enables the psychometric data analytics engine to request panelists who meet at least one demographic criterion.

The sample provider system 106 sends data block 405 to the psychometric data analytic engine 108 (referred to as PDAE 108 herein), which receives as data block 405 access to a set of N4 users that are demographically selected (per the selecting 464 according to at least one criterion), known to have high behavioral data (per the filtering 422) suitably anonymized (by the sample provider). If user IDs are provided by the sample provider system 106, they are anonymized sample-provider user IDs.

In process 482, PDAE 108, by having access to the N4 panelists, obtains measured psychometric information from the panelists. This is carried out without using any PII, e.g., without any panelist's email address or name. In one embodiment, this is carried out by the sample provider system 106's redirecting each of the N4 panelists of received data block 405 to a measuring instrument that measures the dimensions, e.g., via a psychometric-modeling application that is managed, for example, by PDAE 108, and in which the users' psychometric information is measured. In one embodiment, the redirecting is done by sample provider system 106, which invites each of the N4 panelists to click on a URL (called a “redirect URL”) that redirects the panelists away from platform 106 and takes them to a separate psychometric-modeling platform (the measuring instrument) that is operated by code in PDAE 108. In one embodiment, the user's ID (anonymized by the sample provider system 106) is sent as a dynamic variable within the redirect URL in order to keep track of the user's participation in the study, but without PDAE 108 having PII on these users. In one such version, at least one tracking mechanism, e.g. a web pixel, is used to enable the PDAE 108 to obtain the user's (anonymized) user ID.

One aspect of embodiments of the invention is maintaining privacy. In one implementation, a firewall is set up on PDAE 108 that only lets anonymized user IDs in the N4 set of sample provider IDs pass through into PDAE 108's modeling platform. Thus, the step of redirecting the N4 panelists of received data block 405 to a measuring instrument, e.g., a psychometric-modeling application, is carried out without PDAE 108 having any knowledge of any user's personally identifiable information (“PII”).

Recall that in some embodiments, the panelists are those that have undergone a demographic selecting, e.g., demographic balancing process in sample provider system 106. Process 482 collects the dimensions of each panelist. In addition to purely psychometric data, demographic data on the panelist is also made available or collected during process 482 (recall a user's psychometric dimensions as this term is used herein may include at least one demographic trait). In one embodiment, in addition or instead of the any demographic balancing carried out by the sample provider 106, balancing is carried out in process 482 using, e.g., demographics in order to achieve a balanced sample that is representative of the population being modeled. Even if the panelists are selected in 464 to have one or more particular demographic traits, process 482 may include balancing the panelists' other traits. In some implementations, in addition or instead of demographics, other pre-defined pre-screening questions may be used to balance the sample according to psychometric parameters. As an example, this ensures that there are not too many users with the same political leanings or personality traits. As another example, the balancing includes discarding users who do not complete the psychometric modeling application, or who fail validity checks within the survey, e.g., “speeders” who complete the task in less than one third of the median time, or other measured of what forms a valid profile. Thus, the users are selected to have valid psychometric profiles.

One method of carrying out balancing on PDAE 108 (or elsewhere in system 100) comprises presenting at least one pre-screener question of a demographic (which may be geographic, firmographic, and/or of a consumer nature, or purely psychometric nature, to determine whether to include or exclude particular users from being used in PDAE 108 for machine-learning prediction. At least one other data-driven way of discarding users may be included or used instead, e.g., by using Item Response Theory. See for example, An, Xinming, and Yiu-Fai Yung. “Item response theory: what it is and how you can use the IRT procedure to apply it.” SAS Institute Inc. SAS364-2014 (2014).

Thus, balancing in PDAE 108 generates a set of N5 users, typically a subset of the N4 users. Psychometric dimensions that may include at least one demographic trait are obtained for these users so that PDAE 108 has psychometric profiles on the N5 users, such users known to have sufficient behavioral data available, and forming a balanced set. These N5 users form a data block 406.

Note that not all embodiments of the invention include balancing operations as described herein. Thus in some embodiments, N5=N4.

PDAE 108 sends the (anonymized) sample-provider user IDs of the N5 users of data block 406 whose psychometric profiles are available and who are known to have behavioral data to data distributor system 104.

Data distributor system 104 receives data block 406 and in process 446 converts (translates) the sample-provider user IDs to target-provider user IDs using database 144. This forms data block 407 of N5 users in the target population provider system 102's ID system, and this data block 407 is sent to the target population provider system 102.

One aspect of the invention is that psychometric profiles and models are maintained only in PDAE 108. This maintains privacy because entities other than PDAE 108 may have PII on users.

Target population provider system 102 in process 424 obtains or retrieves behavioral data for these N5 panelists for which psychometric profiles have been obtained and are available in PDAE 108. Such behavioral data, e.g., as historical behavioral records, recall, are stored in or available to the target population provider system 102's user database 124. Records for the N5 users in the form of target-provider user IDs and corresponding historical behavioral data forms data block 408 of target population provider users and their behavioral data. In another embodiment, target population provider system 102 may also, or alternatively, begin to collect future behavioral data generated by these N5 users, which may later be passed back to PDAE 108.

Target population provider system 102 sends block 408 of N5 target-provider user IDs and their corresponding historical behavioral records to the data distributor 104 which in process 448 transforms (translates) the target-population-provider-domain IDs back to their corresponding sample-provider-domain IDs to form data block 409 of N5 sample-provider-domain IDs and their corresponding historical behavioral records, and sends data block 409 of N5 (anonymized) sample-provider-domain IDs (or other mechanism for identifying accepted psychometric profiles with the same user's behavioral data) and their corresponding historical behavioral records to PDAE 108.

PDAE 108 receives data block 409 of N5 of user IDs and their historical behavioral records. PDAE carries out analysis of the data in the historical behavioral records, and carries out dimension reduction to summarize the behavioral data, i.e., to form summary behavioral data. In process 484, PDAE 108 joins these historical logs of behavioral data for each of the N5 individual users with each user's directly measured psychometric profiles. These pairs of (summary) behavioral data and corresponding psychometric profile for each of N5 users form a training data set for a machine-learning process that determines (“statistically learns”) a prediction method of predicting a psychometric profile, i.e., determining a psychometric model of a user from the (summary) behavioral data of that user, e.g., by trying one or more prediction methods for each dimension and selecting the best prediction method for each dimension.

Once the prediction method is determined, in one embodiment PDAE 108 sends the target population provider system 102 containing the target population and behavioral data thereof an indication 411 that PDAE 108 can carry out large-scale prediction.

Responsive to knowing that PDAE 108 can carry out predicting, i.e., determining of psychometric models, the target population provider system 102 can prepare, in process 426, at least one data block 412 of N6 users for which system 102 has behavioral data. N6 is typically much larger than the number N5 of users used as the training set. For example, N5 might be thousands of users, while N6 might be millions, hundreds of millions, or even billions of users. Note furthermore that several such data blocks of N6 users may be prepared, at different times, or on a regular continuous basis (e.g., daily or hourly records of all users' behavioral data) and sent through a data feed of data blocks to PDAE 108. As more and more behavioral data becomes associated with a given user ID, the psychometric model generating methods may be used to generate new psychometric models of the user such that the accuracy of psychometric models may increase over time with each refresh.

PDAE 108 receives data block 412 of N6 users, carries out an analysis process to form summary behavioral data of the N6 users and uses the machine-learning-determined psychometric-model-determining methods to determine (and store) psychometric models for the N6 users from the target population provider system 102. In this manner, PDAE 108 can build up a large database of psychometric models of users for which only behavioral data is available.

Note that all, or nearly all, of the users in data block 412 would not have been seed users represented in data block 405 whose psychometric profiles are collected. Even if some of the users in data block 412 did participate in the direct collection of psychometric data, in some embodiments of the invention, only the psychometric-model-determining methods are used for the subsequent steps. In such embodiments, no directly measured psychometric data need be used after step 484, such that the directly measured data and IDs may be erased.

Note also that even those of the N6 users in data block 412 that may have also been part of the N5 users of data block 405 to have psychometric models generated for them by the psychometric-model-determining methods of PDAE 108. This is because PDAE 108 is unable to identify or match the target-provider user IDs in data block 412 with any users in data block 405, because the data block 405 users are passed to PDAE 108 with their sample provider system 106 user IDs, whereas the data block 412 users are passed to PDAE 108 with only their target population provider system 102 user IDs.

FIGS. 4B-4E show diagrams of data flows and processes of alternate embodiments of methods of generating psychometric models of the N6 users, some of which may not have all the advantages of the method described in FIG. 4A. As in FIG. 4A, Note systems 102, 104, 106, and 109 are called “servers” in the drawings.

FIG. 4B illustrates a data flow 410 of a first alternate embodiment in which the sample provider system does not carry out any demographic selecting, e.g., demographic balancing of users. This embodiment may be applicable in situations where privacy is less of a concern, and further more lacks the efficiency of some other embodiments in isolating the seed users. In this embodiment, the data distributor system carries out the matching to determine the N2 users that have target-provider user IDs that also have corresponding sample provider user IDs. Because the sample provider system 106 is no longer involved after providing access to the N1 users, the data distributor system 104 also is no longer involved after the matching process 442. Furthermore, in Step 482, the psychometric balancing generates the N5 seed users, since no demographic balancing is carried out.

FIG. 4C illustrates a data flow 430 of another embodiment in which the sample provider system carries out demographic selecting, e.g., demographic balancing as part of providing access to the N1 users. This embodiment also may be applicable in situations where privacy and/or efficiency are less of a concern. Thus, in step 422, the filtering out from the N2 users those that do not have enough behavioral data results in N4 users who both have enough behavioral data at the target population provider system 102, and that have already been demographically selected, e.g., demographically balanced in step 401. The psychometric balancing of step 482 produces the N5 seed users. Because the sample provider system 106 is no longer involved after providing the N1 users, the data distributor system 104 also is no longer involved after the matching process 442.

FIG. 4D shows a data flow 250 of yet another embodiment in which the obtaining the measured (actual) psychometric profiles of users using the measuring instrument is carried out for all N2 users that are matched with the N1 users to whom access is provided by the sample provider system 106, rather than the users being first filtered to ensure that they have enough behavioral data in the target population provider system 102, as in the data flows of FIGS. 4A-4C. In process 482 in target population provider system 102, psychometric profiles are caused to be measured on these N2 users, and then psychometrically balanced to ensure balanced psychometric profiles, thus generating N4 users what have balanced psychometric profiles. Step 424 then includes filtering out those of the N4 who do not have enough behavioral data to produce the N5 seed users.

FIG. 4E shows a data flow 470 of yet another embodiment applicable in those situations in which the sample provider system 106 provides N1 users who might have target-provider user IDs. As an example, for a situation that looks at activity in Facebook® (and/or, e.g., Reddit®), many of the N1 users to whom the sample provider 106 can provide access may have Facebook® accounts (and/or be on Reddit). In such an embodiment, no separate entity that carries out translation of target-provider user IDs to or from sample-provider user IDs is used, so that the data distributor system 104 that used in the data flows of FIGS. 4A-4D is not needed. The sample provider system 106 in 462 provides access to N1 users (possibly with their anonymized sample-provider user IDs) directly to the PDAE 108, e.g., by directing to a psychometric measuring instrument, e.g., particular web pages managed by the PDAE. Such a web page includes a tracking mechanism for the target population provider, so, for example, the PDAE 108 in 482 directs the users to such a web page that includes a tracking mechanism for the target population provider, so that if the tracking mechanism, e.g., a web pixel fires, or a device ID is captured, and the PDAE 108 knows the user has a target-provider user ID. For example, a Facebook or Reddit® tracking mechanism can be included in the web page and will identify whether or not a user is in Facebook or Reddit (without necessarily revealing the Facebook or Reddit identity, so that anonymity is maintained. For such users, say N2 users who are known via the tracking mechanism to have target-provider user IDs, PDAE 108 obtains the users' measured psychometric profiles. Balancing is carried out to generate N4 users with balanced psychometric profiles. These users' (anonymized) identifiers (obtained via the tracking mechanism) are sent to the target population provider wherein in 424 the behavioral data of the N4 users are retrieved, and filtering may or may not be carried out to remove those users who do not have enough behavioral data to generate the N5 seed users whose behavioral data is sent to the PDAE 108. Note that the data flow 470 of FIG. 4E assumes no demographic selecting, e.g., demographic balancing is carried out in the sample provider system 106. However, a modified version may include some demographic balancing as part of step 462.

Note that yet other alternate embodiments of the invention are possible, and would result in modified versions of these data flows. As one such example, the embodiment of the data flow of FIG. 4E may be modified to include demographic balancing carried out by the sample provider. Since PDAE 108 may have both anonymized sample-provider user IDs and anonymized target-provider user IDs (from the tracking mechanism) of some of the N4 users, their anonymized sample-provider user IDs can be sent to the sample provider system 106 and demographic balancing can be carried out, so that the N5 seed users have data that is demographically balanced by the sample provider system 106 and also filtered to remove users who do not have enough behavioral data.

Some embodiments also include additional data checking by carrying out predicting of psychometric profiles on the N5 using the collected behavioral data, and then comparing the generated psychometric models with the actual collected psychometric profiles. This is a form of cross-validation.

Other embodiments include additional processing of behavioral data to remove any PII that may exist in the actual behavioral data, or immediate deletion of the input behavioral data that may contain PII after the data is processed.

### Dataflow for Use of Psychometric Models for Generating Audiences

Once psychometric models of the overall population of N6 users are available, some embodiments of the invention include using the psychometric models to generate a model (“engagement model”) that predicts the likelihood of engagement with a particular stimulus, e.g., a particular advertisement or a particular video as a function of a user's psychometric model. Some embodiments further include using the engagement model and psychometric models of a population to generate audiences for targeting the particular stimulus.

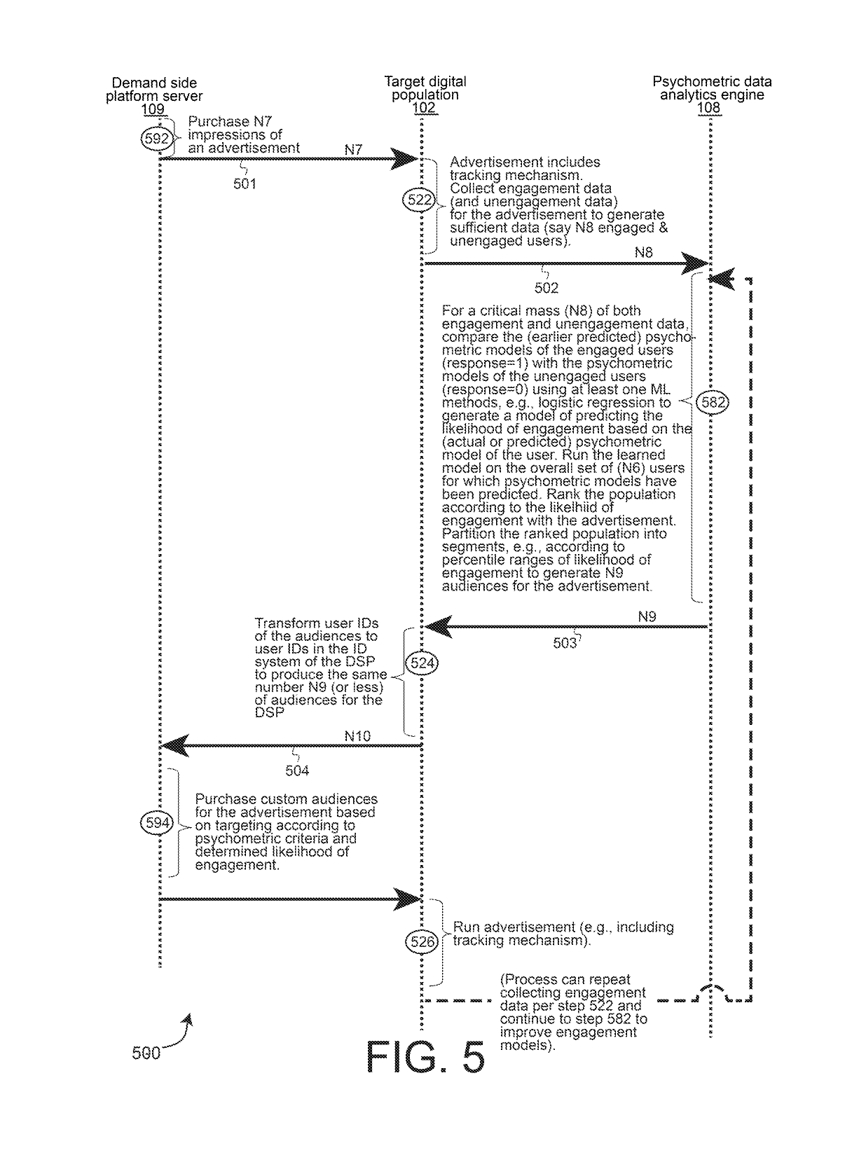

FIG. 5 shows a representation of the data flow 500 between systems 102, 108, and 109 of FIG. 1, and of the data processing carried out as processes in each of the systems with each type of data, according to some embodiments of the invention for using stored psychometric models, e.g., those in PDAE 108 to generate audiences for at least one particular advertisement. As in FIG. 4A-4E, processes carried out in or managed by the target population provider system 102 are shown having reference numerals with a middle digit 2, processes carried out in or managed by psychometric data analytics engine 108 (“PDAE 108”) are shown having a reference numeral with middle digit 8, and processes carried out in or managed by DSP 109 have a reference numeral with a middle digit 9.

In some such embodiments, in process 592, a number denoted N7 of impressions of a particular advertisement are purchased at DSP 109 for the target population provider system 102. The data for the advertisement is shown as data block 501 and information therein is sent to target population provider system 102. Note that this process 592 can be carried out for more than one advertisement, and/or for at least one particular element of at least one advertisement. The process 592 also may purchase a video element to be viewed, and/or some other message. For purpose of explanation, and not to limit the invention, the case of a single particular advertisement is described, unless otherwise specified.

Target population provider system 102 receives the advertisement, as well as the bid(s) to serve ad impressions to the users of target population provider system 102, from an advertiser (or an agency associated with the advertiser, or even the DSP) via the DSP. The method includes in process 522 the target population provider system 102 (itself, or arranging for) serving the advertisement to many users of target population provider system 102, for example to hundreds of thousands or to millions of such users. In one embodiment, target population provider system 102 serves the advertisement, while in another implementation, the advertisement is served to a population on a target population provider other than target population provider system 102. In either case, at least one tracking mechanism, such as a web pixel or some tracking code is installed in the main web page (the so-called landing web page) of the advertisement, and configured to track a visitor of the landing web page in response to such visitor's interacting with, e.g., clicking on at least one specified creative element in the advertisement for which the tracking mechanism or mechanisms is or are designed. In this way, at least one tracking mechanism enables target population provider system 102 to capture and record the target-provider user IDs that engage with at least one pre-specified creative element of the served advertisement. We call the data collected on users that relate to the advertisement “engagement data” that is collected in (or provided to) the target population provider system 102. We call the mechanism and system for capturing the engagement data an “engagement-measuring instrument.” In some embodiments, the engagement instrument collects, in addition to the engagement data of users who engage with the advertisement, the user IDs of users who were served the advertisement and chose not to engage with the advertisement also is collected by (or sent to) the target population provider system 102. Such data is called “unengagement data” herein. While some embodiments may separate data on those users who do engage from data on those who choose not to engage, the term engagement data as used herein includes the unengagement data, whether collected by the engagement measuring instrument, or inferred from the data on those who engage. Note that for simplicity of explanation, engagement data is limited to binary valued data, e.g., a use did or did not engage with the stimulus. However, some embodiments include using several types of tracking mechanisms such as different types of web pixels in the served advertisement. Each type of tracking mechanism may be associated with a particular type of pre-specified action by the user, and is configured to record the user IDs of users that undertake the associated pre-specified action. Examples of such actions associated with types of tracking mechanisms include (but are not limited to) filling out a form, buying a product, downloading an application or file, viewing a video in part or to completion, and even receiving an advertisement impression (regardless of whether or not the user interacts with the impression). Therefore, while the description herein concentrates on binary valued engagement data, other types of engagement data are other than binary valued, and might include, e.g., viewability metrics, meaning the amount of time a user engages with an element on the publisher's web page or on the ad's landing web page.

In one embodiment, the engagement instrument of target population provider system 102 sends these engagement data (including the unengagement data), as data block 502 of N8 users, to PDAE 108. In one embodiment, target population provider system 102, in preparation for the sending, first ascertains whether or not there is a sufficient number (a “critical mass”) N8 of users in the engagement data. In another embodiment, the engagement instrument sends all engagement data to PDAE 108, and any ascertaining whether there is a sufficient amount of engagement data is carried out by PDAE 108. According to such other embodiment, PDAE 108 receives the engagement data and ascertains whether PDAE 108 has engagement data for the advertisement on a pre-defined minimum number of users (the critical mass N8). In one version, the pre-defined minimum number of users is 200, and typically, this number is settable.

Recall that the engagement data and unengagement data are of users whose predicted psychometric profiles are known, i.e., have been predicted in PDAE 108. The method continues in 582 with PDAE 108 “comparing” psychometric models of the users in the engagement data with the psychometric models of users in the unengagement data.

Note that while in one embodiment, true collected unengagement data for a particular advertisement is used for the comparing of psychometric models, in an alternative embodiment, simulated unengagement data is used by selecting a random set of users from the general population of users whose psychometric models are known, such random set forming the unengagement data for the comparison.

In 582, for the critical mass (N8) of both engagement and unengagement data, for the case of binary valued data, where, for example, engagement means a response of 1, and unengagement means a response of 0, PDAE 108 runs at least one machine-learning process using the (earlier generated) psychometric models of the engaged users and the psychometric models of the unengaged users to generate a model of predicting the likelihood of engagement based on the (actual or predicted) psychometric profile of the user. In one embodiment, the at least one machine-learning method includes logistic regression. In one such embodiment, the at least one machine-learning method includes logistic regression and at least one other machine-learning method, and cross-validation is used to select the best engagement model.

In another embodiment, the at least one machine-learning method includes carrying out unsupervised clustering on an assumed number of clusters, e.g., three clusters, or four clusters, using the psychometric models as features, and examining the so-formed clusters to select the one or more clusters that has the largest proportion or the greatest number of engaged users. These clusters form a learned classification method that can be used to classify users according to engagement, i.e., an engagement model.

Note that engagement can also be a non-binary valued outcome, e.g., the amount of time in seconds a user watches a video advertisement. In such a case, in one embodiment, at least one multiclass classification method, e.g., converted into at least one binary classification method is used for the at least one machine-learning method to determine the engagement model.

Considering embodiments that use logistic regression for engagement/unengagement binary valued data, as described in more detail herein below, the results of logistic regression is an engagement model of a psychometric profile which may be expressed in the form of the natural log of the odds ratio of engagement as a function of the psychometric profile, the function being a (weighted) linear combination of the dimensions of the psychometric profile. Denoting the weighting coefficients of the linear combination by β₀ and β₁, β₂, . . . , β_{P} for the first, second, . . . , P'th dimension of the profile, then

ln(odds-ratio)=β₀+β₁pᵤ₁+β₂pᵤ₂ . . . β_{P}p_{uP}

where ln( ) is the logarithm base e and pᵤ₁, pᵤ₂, . . . , p_{uP} are the P dimensions of the profile. So for any dimension of a psychometric profile, say the i'th, the value of exp(βᵢ) is the odds ratio for engagement for the i'th dimension, keeping all other dimensions constant. This provides, for the particular advertisement, the relative likelihood of engagement for any given psychometric (purely psychometric or demographic) dimension. This is a useful way for potential advertisers to assess the likely impact of a particular stimulus as a function of psychometric (purely psychometric or demographic) dimensions.

Thus, the predictive engagement model can be expressed as Odds Ratios such that users ranked more highly in a given psychometric dimension (possibly being a demographic trait) are an indicated times more likely (or less likely) to engage with the particular advertisement (the advertising stimulus). For example, religious users may be three times less likely to engage with a given advertisement, and users who are psychometrically predicted (via the psychometric model) to be Hispanic may be 2.2 times as likely to engage with it.

Continuing with process 582 of FIG. 5, once PDAE 108 has determined the engagement model for an advertisement, PDAE 108 can as part of process 582 rank the entire population of (N6) users whose psychometric models are stored, which may number in the hundreds of millions or some billions, and thus rank all users (and any associated anonymized user IDs) from those most likely to engage with the advertisement to those least likely to engage.

One embodiment includes, in 582, further partitioning the ranked population into segments, e.g., according to percentile ranges of likelihood of engagement to generate N9 audiences for the advertisement, each audience being in a different percentile range of likelihood of engagement. For example, suppose the served advertisement is called “Advertisement A.” One partition may be called “users in the top 1% of likelihood of engaging with Advertisement A,” and another may be called “users in the top 2 to 5% of likelihood of engaging with Advertisement A,” and so forth. Each of these audiences may contain millions of users, so that the method is called generating audiences for a particular advertisement. Such audiences may be generated for different particular advertisements.

The (anonymized) user IDs of the users in each of the partitions may be sent as data block 503 to the target population provider system 102, wherein the method in 524 may transform the target-population user IDs of the users of the audiences into N10 audiences, e.g., N9 audiences (or fewer audiences) for the DSP system 109. These N10 audiences are sent as data block 504 to the DSP system 109.

Continuing with the data flow of FIG. 5, in one embodiment, PDAE 108 may send the N9 generated audiences to target population provider system 102 as data block 503. In one embodiment of this invention, target population provider system 102 in process 524 may translate the IDs in each of the N9 audience into a tracking system of another target population provider, such as a Demand Side Platform (DSP), e.g., DSP 109. This may result in a number N10 of audiences, where N10≤N9 (since some of the users may not be successfully matched to the DSP), and send these audience lists as data block 504 to the DSP 109 where they can be accessed by the media trader of an advertiser or agency, who may have access to the DSP, e.g., within a so-called Private Marketplace (PMP). Such custom psychometrically-generated audience segments can be used as targeting data hopefully to significantly increase the engagement rates of new users with the same advertising stimulus, or advertisements having similar creative elements.

While the term advertisement is used herein, it is to be understood that embodiments of the present invention are usable to predict user engagement with at least one stimulus other than an advertisement, e.g., presentation of content for purpose or purposes other than advertising.

Over time, PDAE 108 may accumulate engagement data from advertising campaigns (including attention metrics, click-through rates, conversions, etc.) that PDAE 108 feeds into its machine-learning module 189, to improve the initial targeting (pre-optimizations) of psychometric audiences for advertisements with specific attributes. For example, learning module 189 may determine that advertisements in a certain product category, or with certain colors, images, audio, or messages, may achieve higher rates of engagement if these stimuli are served to users with certain combinations of psychometric traits.

Thus, as shown by in FIG. 5, the process may repeat collecting engagement data per step 522 and, continue to step 582 to improve the engagement model, and any data determined therefrom).

Another use of embodiments of the invention is assessing audiences that are pre-ordered with one or more traits. As one example, a designated market area (DMA), also called a television market area, is a region of a country where the population can receive the same (or similar) television and radio station advertisements, and may also include other types of media including newspapers and Internet content. One example use of an embodiment is to have the users be categorized according to their DMA. The embodiment of the invention can rank each of the country's DMAs according to its psychometric fit with a specific video advertisement's engagement model. The same can be done for smaller geographic areas, including but not limited to zip or postal codes.

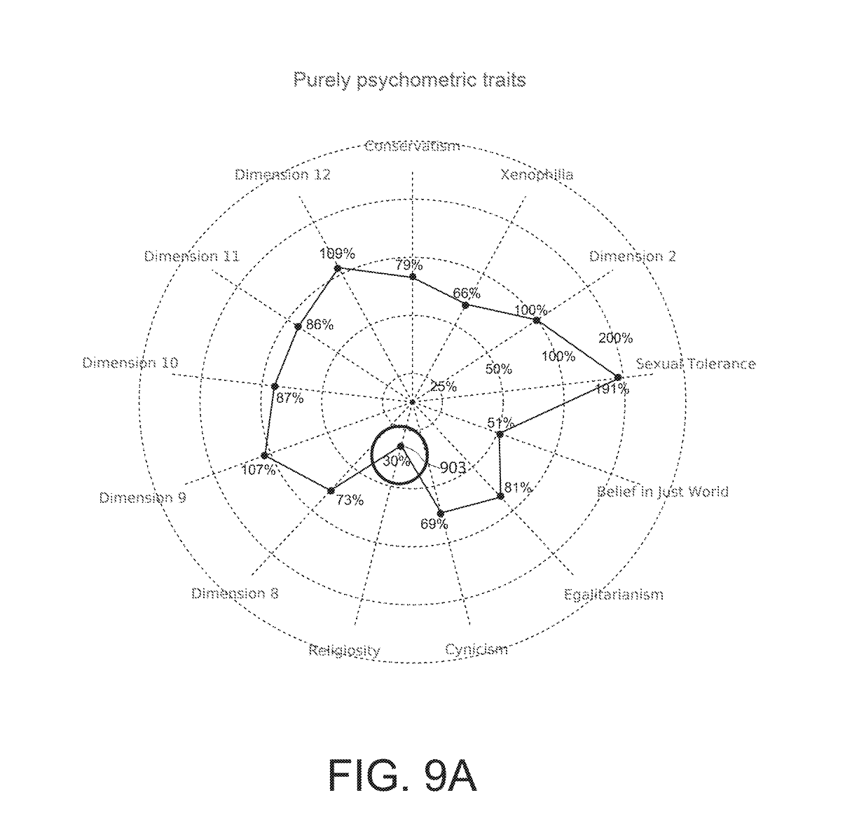

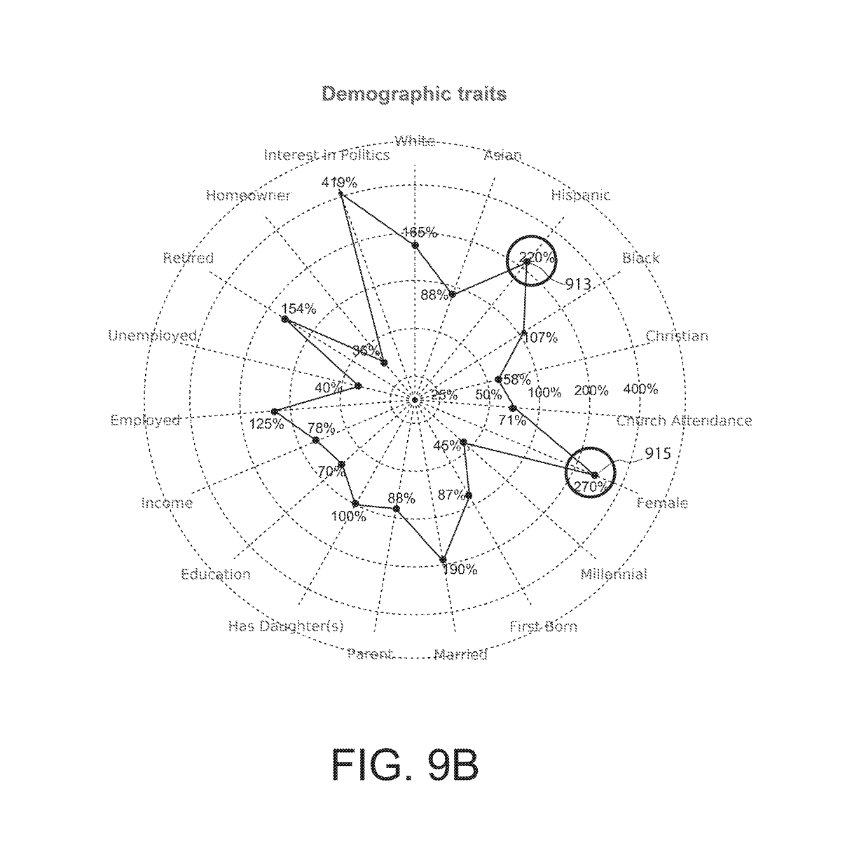

Advantageously, due to the lack of users' PII, interrogation of the user IDs though surreptitious means would provide only predictive models linked to a target population provider's cookies, and these cookies or other IDs may be themselves encrypted. Under an intended use of one embodiment of the invention, the psychometric data that comprises the psychometric models for each user (or some privacy-sensitive subset of the psychometric dimensions comprising the model) can be kept private in the psychometric data analytics engine (PDAE 108). These data are used only for the purpose of generating custom psychometric audiences for specific targeting purposes. Audiences (lists of IDs) may be created based on numerous psychometric measurements, without ever revealing how any individual user, or any small group of users, specifically fits into the overall engagement model (e.g., a user's psychometric profile share similar scores on some dimensions with an advertisement's overall engagement model, but not on other dimensions). At the same time, engagement models of large groups of users can be characterized by trends that express odds ratios or percentages of positive or negative lift (see FIGS. 9A and 9B) to provide advertisers with valuable engagement insights that pertain to large groups.

In addition, data processing system 100 can work with any platform that has user IDs and behavioral or consumer data, including but not limited to on-line dating platforms, social-media platforms, entertainment or other applications, large publisher or publisher-network platforms, financial platforms with consumer data, and government/intelligence platforms with user-generated language data. Each of these falls within the definition of a platform as used herein.

### A Special Purpose Hardware System

As described above, FIG. 1 shows one embodiment of a system 100 for predicting psychometric profiles of online users to form psychometric models of the users. As discussed herein, the system comprises a measuring instrument (105) configured to measure psychometric dimensions of users of a first set of users, and a psychometric data analytics engine system (PDAE 108) coupled to the measuring instrument. The PDAE 108 comprises a processor set 184 comprising at least one processor, and a storage subsystem 186 (that in general includes memory and other storage, and thus comprises a non-transitory computer-readable medium). The storage subsystem comprises, i.e., the a non-transitory computer-readable medium stores code (187, 188, 189) that when executed by at least one processor of the processor set 182, carries out any one of the machine-executed methods described herein of predicting psychometric profiles of online users. Some embodiments also carry out any of the methods described herein of predicting a model of likelihood of engagement with a particular stimulus by online users as a function of psychometric models of the users.

Some embodiments of the invention comprise a hardware system that includes special purpose hardware elements configured to carry out one or more of the steps of carrying out one or more of the methods described hereinabove. FIG. 6 shows one embodiment of such a hardware system 600 for using machine-learning and includes, as in FIG. 1, the psychometric measuring instrument 105 and a psychometric data analytics engine system (PDAE) 602 that includes special purpose hardware. The system 600 may include at least one client 103 (three are shown), and may include at least some of systems 102, 104, 106, and 109 that are described hereinabove.

The PDAE 602 includes a controller 680 and a storage subsystem 682 coupled to the controller. The controller may include at least one programmable processor. The storage subsystem 682 may include memory and other storage devices, and stores controller program code 622 and in some versions other program code 624 usable by one or another of the elements coupled with the storage subsystem 682. The storage subsystem 182 also is configured to store a cookied user database (cookied user DB) 184 that in one embodiment is the same as element 184 of PDAE 108 of FIG. 1. The PDAE 602 may comprise an interface 604 configured to interface the PDAE with the network and other devices.

The PDAE 602 comprises a machine-learning engine 610 coupled to the controller and configured to carry out at least one machine-learning method. In some embodiments, the machine-learning engine may be coupled to the storage subsystem 682 and may be reconfigured, under control of the controller 680, to load at least one additional machine-learning method, to modify any of its machine-learning methods, or to remove any of its machine-learning methods. Carrying out such reconfiguration may include loading some of the other program code 624. The machine-learning engine 610 may include logic hardware configured to carry out at least part of the at least one machine-learning method. The machine-learning engine may additionally include a storage device storing machine executable code that together with the logic hardware causes the machine-learning engine to carry out the at least one machine-learning method. Such code is shown as ML1, ML2, . . . in FIG. 6.

For operating embodiments that carry out the training of machine-learning methods and the generating of psychometric models, the interface 604 under control of the controller 680 is configured to accept from the measuring instrument 105 measured psychometric dimensions of users of a first set of users to form accepted psychometric profiles of users of the first set, e.g., in the cookied DB 184. The interface 604 under control of the controller 680 also is configured to accept automatically-machine-collected data about online behavior of users of a second set of users. Such accepted data is to form summary behavioral data. Each user of the second set also is in the first set. Thus, PDAE 680 is configured to have for each user of the second set, e.g., to have stored in the in the cookied DB 184 both the accepted measured psychometric profile and the summary behavioral data of said each user. For such embodiments that train machine-learning methods and that generate psychometric models, the controller 680 of PDAE 602 is coupled to and configured to control a psychometric modeling engine 608 that is coupled to the machine-learning engine, and configured to use the summary behavioral data and the corresponding accepted measured psychometric profiles of the users of the second set to cause training, using the machine-learning engine, at least one respective machine-learning method of predicting each respective dimension of psychometric profiles of users whose psychometric profiles may be unknown. The interface under control of the controller also is configured to accept automatically-machine-collected data about online behavior of users of a third set of users whose psychometric profiles may be unknown, this to form summary behavioral data of the users of the third set. The psychometric modeling engine, under control of the controller 680 is configured to use at least one of the trained machine-learning methods of predicting to generate psychometric models of each of the third set of users from the summary behavioral data of the users of the third set, and to store the predicted psychometric models, e.g., in the DB 184. The PDAE 602 is configured to maintain anonymity of each of the users of the first, second, and third sets of users.

Some embodiments of PDAE 602 also include an analysis engine 606 coupled to and under control of the controller 680. The analysis engine 606 is configured to carry out an analysis process on the accepted automatically machine-collected data on online behavior of users to form the summary behavioral data. The analysis engine 606 is coupled to the storage subsystem 682, in particular to the cookied user DB 184. The analysis engine also is coupled to the machine-learning engine, and, in embodiments that carry out analysis by unsupervised learning, uses at least one unsupervised learning method that is included in the at least one machine-learning method that the machine-learning engine is configured to carry out.

For operating embodiments that carry out using psychometric models of users and engagement data to form a model to predict the likelihood of engagement with a particular stimulus, e.g., an online advertisement, the interface 604 under control of the controller 680 is configured to accept from an engagement measuring instrument (e.g., clients 103) engagement data on users who engage with the particular stimulus and for whom predicted psychometric models are stored, e.g., in 114 of user database 184. For such embodiments, the controller 680 of PDAE 602 is coupled to and configured to control an engagement modeling engine 612 that is coupled to the machine-learning engine 610 and the storage subsystem 682, and configured to retrieve (304) stored psychometric models (114) of users whose engagement data are accepted. The engagement modeling engine 612 further is configured to cause the machine-learning engine 610 to use both accepted engagement data (115) on the users whose psychometric models are retrieved and the retrieved psychometric models (114). to train (306) at least one of the machine-learning engine's machine-learning methods to determine an engagement model (116) that predicts a measure of the likelihood of engagement for a user whose engagement data may be unknown, based on the psychometric model of the user whose engagement data may be unknown. In some versions, the engagement modeling engine 612 further is configured to apply the engagement model to a population of users whose psychometric models are available, e.g., in 114 to predict respective measures of the likelihood of engagement with the particular stimulus for respective users of the population. In some versions, engagement modeling engine 612 further is configured to rank the population of users according to the measure. In some embodiments, the engagement modeling engine 612 further is configured to partition the ranked population into a set of audiences (117), each respective audience consisting of respective users of a respective range in the ranking. In some embodiments, the engagement modeling engine 612 further is configured to carry at least one of the set of actions consisting of targeting the particular stimulus to users having at least one particular psychometric dimension, and comparing the engagement model for the particular stimulus to at least one engagement model for at least one other particular stimulus.

The analysis engine 606 may include logic hardware configured to carry out at least part of the analysis process, and may additionally include programmable processing circuitry and a (non-transitory) storage medium storing machine executable code 607 that is used by its processing circuitry. The psychometric modeling engine 608 may include logic hardware configured to carry out at least part of the processes the psychometric modeling engine is configured to perform, and may additionally include programmable processing circuitry and a (non-transitory) storage medium storing machine executable code 609 that is used by its processing circuitry. The engagement modeling engine 612 may include logic hardware configured to carry out at least part of the processes the engagement modeling engine is configured to perform, and may additionally include programmable processing circuitry and a (non-transitory) storage medium storing machine executable code 613 that is used by its processing circuitry.

### Collecting and Analyzing Users' Behavioral Data and Topic Modeling

Automatically collected behavioral data on users as used herein means online activity (including activity on its application, network, or exchange). While in many examples embodiments described herein, behavioral data includes data on websites visited by users, behavioral data may include user-generated text in an application, and/or consumer data, and/or user-preference data, and/or first-party data, and/or web-log data. While the analysis method described herein above is for textual analysis of websites visited by users, behavioral data may include or instead be comprised of one or more of images, audio, text messages, emails, blogs produced (or read), data documents, text files, database files, log files, transaction records, purchase orders, and so forth. Thus, while the analysis process described herein comprises analyzing text from online behavior, the analyzing for example including applying unsupervised classification to the text, in other embodiments the analysis process to form the summary behavioral data for a user comprises analyzing at least one image and/or at least one audio element from online behavior of the user, the analyzing for example including applying unsupervised classification to the at least one image and/or at least one audio element. Carrying our such analysis of images and/or audio elements is known, and how to modify the methods and systems described herein to include summary behavioral data from images and/or audio elements would be clear to one of ordinary skill in the art using known methods of analyzing images and/or audio elements.

For purpose of completeness, embodiments that track users by analyzing the text of websites visited by each user to generate behavioral data for the user are described in detail herein. The text of the websites visited by the users includes many words, and one aspect of the invention is analyzing the automatically collected data to convert the website data into a set of “features.” Many methods are known for converting text documents, e.g., websites to “features.” Such methods are sometimes called document classification, and involve assigning at least one class of a set of classes to each document, e.g., website of a set of documents, e.g., a set of websites. Thus a subset of the set of classes is assigned to each document of the set of documents. This therefore achieves a form of reducing the dimensionality of the documents into a set of classifications that the documents are described by, and some measure of each such classification. Many methods are known for text document classification, and such methods may be supervised, unsupervised and semi-supervised. Supervised methods involve a classifier being trained on data previously labeled by human assessors. Unsupervised classification is carried out by machine without human assistance, and sometimes even without the set of classifications being pre-defined.

Some methods of representing text, e.g., Web documents include representing the text of web pages or top level web domains as vector space models, and then applying one or more methods to reduce dimensionality. Such methods include matrix methods such as alternating least squares (ALS) and singular value decomposition (SVD).

Some embodiments of the invention use unsupervised classification, in particular topic modeling, which is the process of analyzing all text of all websites visited by users to automatically determine inherent classifications of the text into what are called topics. Thus all websites visited by all users, which might be in the order of tens of millions, can be represented by a relatively small number of topics, e.g., in the order of hundreds of topics. Each document can then be described by its topic distribution of the relatively small number of topics.

In one embodiment, the number of topics, let us denote it by K, is 800. Other values for K, i.e., other numbers of topics, may be used in alternate embodiments.

One topic modeling method that could be used is called probabilistic latent semantic analysis (PLSA), and is based on a mixture decomposition derived from a latent class model. With PLSA models, the probability of each co-occurrence of words and documents as a mixture of conditionally independent multinomial distribution. A number of parameters needs to be learned, and typically, the expectation-maximization algorithm is used to learn the parameters.

Another topic-modeling method, and the one actually used in some embodiments of the invention, is called latent Dirichlet allocation (LDA), and this method creates a model of topics (a topic model) in the corpus of websites. Like PLSA, LDA is a probabilistic technique used to create topic models. However, the topic distribution is assumed to have a Dirichlet prior distribution.

The LDA topic modeling method involves what is commonly called a “bag of words” approach. In this model, text is represented as the bag (multiset) of its words, disregarding grammar and even word order but keeping multiplicity. In a bag of words approach, words are taken one at a time, and their frequency of occurrence is recorded. Alternate embodiments of the invention may use N-gram models which store the spatial information within the text, i.e., not just single words, but more than one word at a time. A bigram model for example parses text into two-word terms, and stores the frequency of each word-pair term. For example, the term “White House” would appear as a single token in a bigram model.

In more detail, describing the method used in some embodiments of the invention, assume websites are represented by html code, and assume that behavioral data for any user includes the websites that the user has visited.

Let there be the U users. By the corpus is meant all the websites visited by all users. Denote as sᵤₘ, m=1, . . . Mᵤ, u=1, . . . U the m'th website visited by the u'th user, where Mᵤ denotes the number of distinct websites visited by the u'th user. Also, denote by sₘ the m'th website visited by any one of the U users, so that and suppose there are M websites in total visited by any user. The corpus [symbol] is the union of all websites visited by any user, i.e., [symbol] =U=ₘ₌₁^{M} sₘ. Note that while more than one user may visit any one website, that one website is “counted” only once, i.e., once the website is visited by any user, it is part of the corpus whether or not it is visited again by the same or some other user, and no matter how many times it is visited.

Tokenization is the process of splitting the textual content contained within the body of a website into words (or tokens) by removing all punctuation marks, by replacing tabs and other non-text characters by single white spaces, and in some versions, by removing so-called stop words, e.g. prepositions, articles, conjunctions etc. that have little information content. Some embodiments of tokenization also include stemming, which involves reducing inflected (or sometimes derived) words to their stem or root form. Per the bag of words approach, the resulting words and their frequency of occurrence is recorded.

The set of unique words in the corpus is called the dictionary. The dictionary is part of the vocabulary. Denote by V the number of words in the vocabulary. Denote by Nₘ the number of words in website sₘ, and denote by N the number of words in the dictionary of all websites, so that N=Σₘ₌₁^{M} Nₘ. In one embodiment described herein, N=V, such that it is assumed that all websites contain all words in the vocabulary, such the dictionary is the same as the vocabulary.

As mentioned above, some embodiment of the invention use LDA to create a model of topics in (a topic model) the corpus of websites. LDA is described in David M Blei, Andrew Y Ng, Michael I Jordan, “Latent Dirichlet Allocation,” Journal of Machine-learning research, vol. 4, pp. 883-1022, January 2003. See also en˜dot˜wikipedia˜dot˜org/wiki/Latent_Dirichlet_allocation, retrieved 2016 May 27, where ˜dot˜ denotes the period (“.”) character in the actual URL. LDA is a probabilistic technique used to create topic models. Initially, we are not concerned with individual users, simply the corpus, word counts, and the global dictionary. The LDA algorithm generates a list of K topics, and for each topic k, a measure denoted φ_{kw}, k=1, . . . , K, w=1, . . . , V of the probability of finding word w in topic k. Thus, suppose the LDA topics include a first topic k1 related to cooking, and a second topic, say denoted k2 related to basketball. Then the probability measure values φ_{k1w} would be relatively high for words (w's) like “pan”, “onions”, and “baking”, whereas the probability measure values φ_{k2w} would be relatively higher for words (w's) like “dribbling”, “timeout”, and “court,” and lower for worlds like “pan”, “onions”, and “baking”. The LDA model also generates a “topic distribution” denoted θₘₖ, m=1, . . . , M, k=1, . . . , K, which is a measure of the probability of a topic k occurring in the m'th website (in general, the probability of a topic k occurring in the m'th document) of the corpus [symbol] .

Once we have the topic distributions for each website of the corpus [symbol] , given a record of the websites visited by each of the users, the method includes creating “behavioral feature vectors” for each of the users. The historical behavior of each user may be described by a “topic vector” of the user, having the same dimension K as the number of topics in the corpus of all websites visited by all users, with each element, say the k'th element, k=1, . . . , K being indicative of the probability of the respective topic, i.e., the k'th topic being in the set of websites visited by that user, so that the sum of all elements of any user's topic vectors is 1.

Recall that u represents the u'th user of a set of U users. For each user u, u=1, . . . , U, the topic-determining method uses an html parser to extract text from all distinct web pages that the user has visited. Suppose a user u visits Mᵤ websites denoted sᵤₘ, m=1, . . . , M, u=1, . . . , U. Recall that each of these websites has a topic distribution. Denote the topic distributions of the websites sᵤₘ visited by user u as θₘ_{ᵤ}ₖ, mᵤ=1, . . . , Mᵤ, k=1, . . . , K. The topic vector denoted tᵤ for any user u is a vector of K elements with the k'th element being indicative of the average of the k'th element of the topic distributions of all the sites the user has visited. That is, denoting by tᵤ=[tᵤ₁ tᵤ₂ . . . tᵤₖ . . . t_{uK}] with k'th element tᵤₖ, then

$${t}_{uk} = \frac{1}{{M}_{u}} {\sum }_{{m}_{u} = 1}^{{M}_{u}} {θ}_{{m}_{u} k} .$$

The number of topics, K, is a parameter that is typically chosen to be large enough such that individual topics are not too similar to each other, but small enough that the topics don't become too abstract or specific. In one embodiment, the corpus consists of tens of millions of websites, with roughly 100,000 unique words, and 800 topics. For this set of parameters, each user would have a topic vector consisting of 800 values ranging from 0 to 1 (0 representing zero probability of a topic).

Note that while one set of embodiments that generated summary behavioral data by topic models uses LDA for the topic modeling, another set of embodiments uses hierarchical LDA according to which the distribution of topics within documents (within web pages) includes organizing the topics into a tree. Each document is generated by the topics along a single path of this tree. When learning the model from data, the sampler alternates between choosing a new path through the tree for each document and assigning each word in each document to a topic along the chosen path. See D. M. Blei, T. L. Griffiths, M. I. Jordan, and J. B. Tenenbaum. “Hierarchical topic models and the nested Chinese restaurant process,” Advances in neural information processing systems. (NIPS), vol. 176 p. 17, 2004. Other embodiments use Pachinko allocation for topic modeling, which incorporates correlation between topics. Pachinko allocation models documents as a mixture of distributions over a single set of topics, using a directed acyclic graph (“DAG”) to represent topic occurrences. See Li, Wei; McCallum, Andrew, “Pachinko Allocation: DAG-Structured Mixture Models of Topic Correlations,” Proceedings of the 23rd International Conference on Machine-learning, 2006. Yet another set uses Hierarchical LDA and Pachinko Allocation that extends the basic Pachinko Allocation structure to represent hierarchical topics. See Mimno, David, Wei Li, and Andrew McCallum. “Mixtures of hierarchical topics with pachinko allocation,” Proceedings of the 24th international conference on machine-learning. ACM, 2007. Other embodiments use Word2vec (see Mikolov, Tomas, Kai Chen, Greg Corrado, and Jeffrey Dean. “Efficient estimation of word representations in vector space.” arXiv preprint arXiv:1301.3781 (2013)).

While some embodiments described herein use the LDA method included in the Machine-learning module (MLib) in APACHE SPARK™ (see the section below titled “A note on the computing environment”, some of the topic-modeling methods described herein are implemented using the Stanford Topic Modeling Toolbox, version 4.3, available 2016 Jun. 1 at nlp˜dot˜stanford˜dot˜edu/software/tmt/tmt-0˜dot˜3/, where ˜dot˜ represents the period character (“.”) in the actual URL. Alternate embodiments use program code available from the “Machine-learning for LanguagE Toolkit” (MALLET) available from the University of Massachusetts, Amherst, Mass. See mallet˜dot˜cs˜dot˜umass˜dot˜edu/topics˜dot˜php, retrieved 2017 Mar. 30, where ˜dot˜ represents the period character (“.”) in the actual URL. See also Shawn Graham, Scott Weingart and lan Milligan “Getting Started with Topic Modeling and MALLET” dated 2012 Sep. 2, and retrievable 2017 Mar. 30 at programminghistorian˜dot˜orq/lessons/topic-modeling-and-mallet,

where ˜dot˜ represents the period character (“.”) in the actual URL.

### Machine-Learning Method of Generating the Psychometric Models

Again, the following is for the case of the summary behavioral data including a topic vector, and other embodiments of the invention use other methods of analyzing the data and other forms of summary behavioral data.

For each of the N5 users, say the u'th user for whom seed data is available, there is a topic vector tᵤ, a vector of P psychometric dimensions obtained for user u by the users via the psychometric measuring instrument, e.g., by interacting with a user interface and entering data, denoted as pᵤ, forming the psychometric profile, with tᵤ=[tᵤ₁ tᵤ₂ . . . tᵤₖ . . . t_{uK}] and pᵤ=[pᵤ₁ pᵤ₂ . . . p_{uP}]. In some versions, at least one of the P psychometric dimensions is demographic, while the remaining are purely psychometric.

Obtaining the psychometric profiles of the N5 users in one version is carried out in step 282 by having the N4 (N4≥N5) users provided by the sample provider system 106 carry out surveys about such demographic factors as gender, race, age, and income level, and such purely psychometric responses as political personality (which may include a participant's level of conservatism, a person's political attitudes, ethnocentrism, religiosity, sexual intolerance, authority and inequality in society, authority and inequality in the family, and perceptions of human nature and so forth).

### Purely Psychometric Dimensions

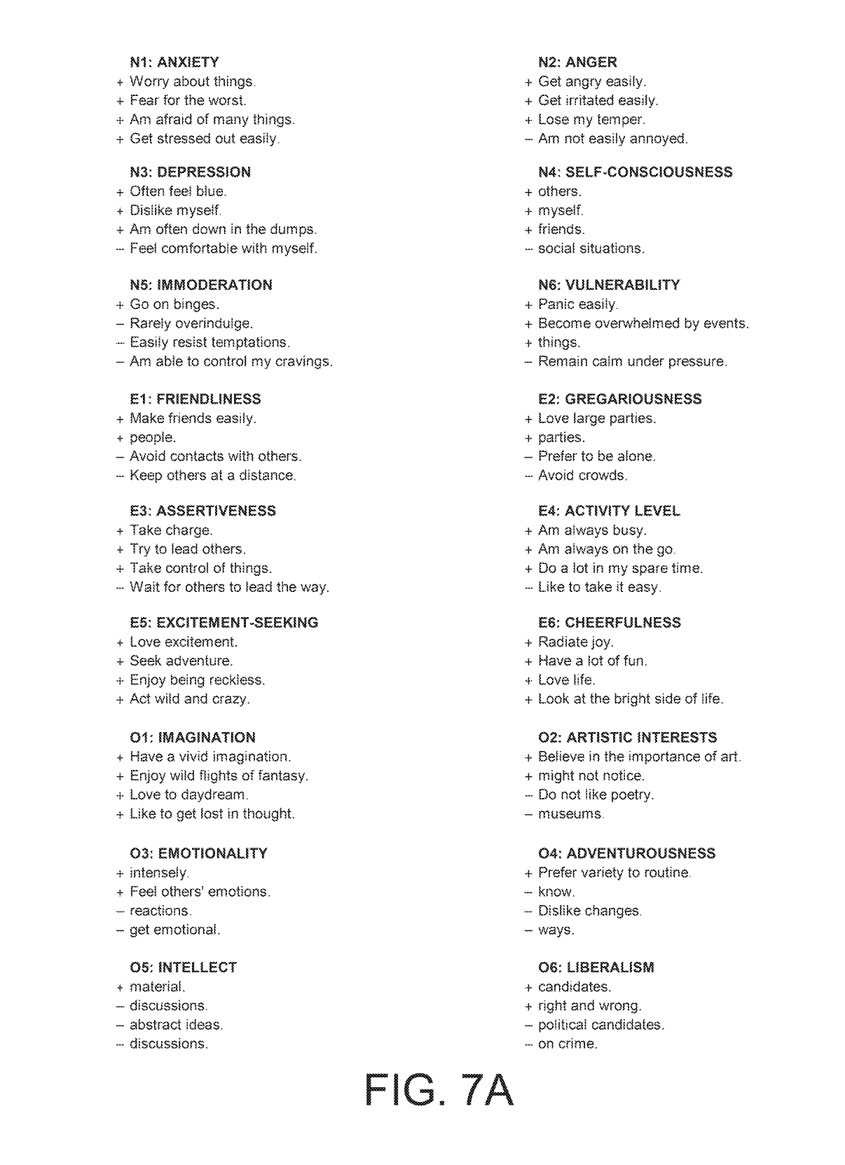

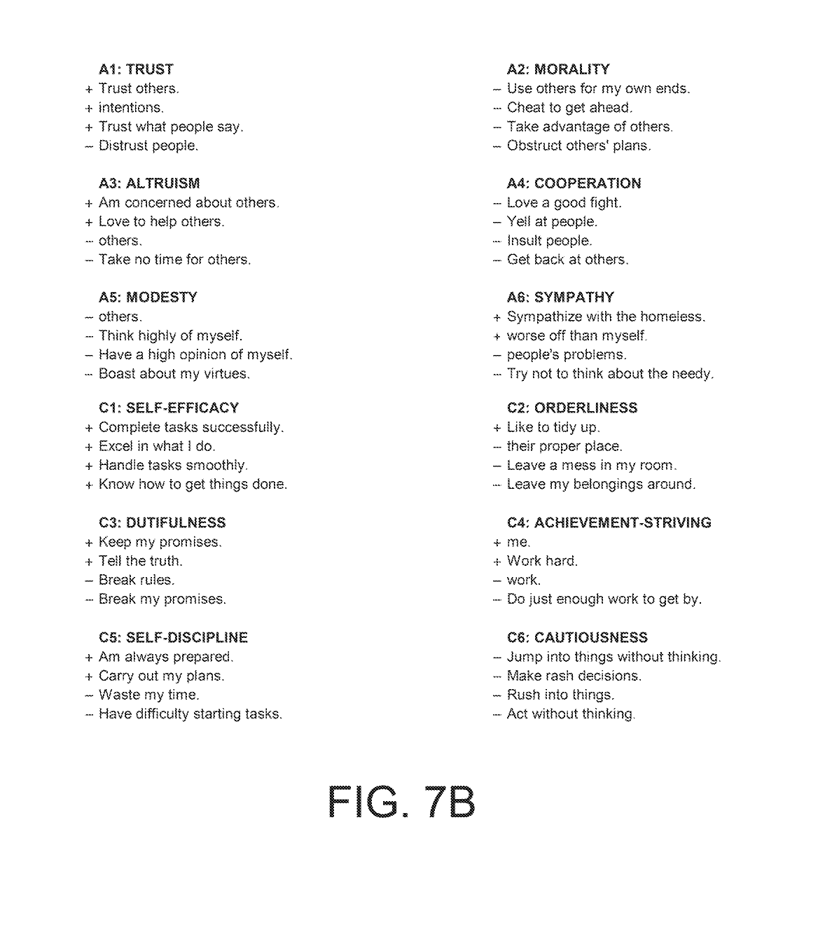

Different embodiments may use different purely psychometric dimensions in the psychometric profile that includes purely psychometric dimensions and optionally at least one demographic dimension. Many inventories of purely psychometric dimensions are known. See for example, “Multi-Construct IPIP Inventories” published at the International Personality Item Pool (IPIP), which is a scientific collaboration for the development of advanced measures of personality and other individual differences, available 2017 Apr. 4 at ipip˜dot˜ori˜dot˜orq/newMultipleconstructs˜dot˜htm, where ˜dot˜ denotes the period character (“.”) in the actual URL. One set of embodiments uses the set of 30 psychometric traits, and definitions published in Johnson, J. A., “Measuring thirty facets of the Five Factor Model with a 124-item public domain inventory: Development of the IPIP-NEO-124.” Journal of Research in Personality, vol. 51, pp. 78-89, 2014. This set is available online on 2017 Apr. 4 at ipip˜dot˜ori˜dot˜org/30FacetNEO-PI-RItems˜dot˜htm, where ˜dot˜ denotes the period character (“.”) in the actual URL. The traits of the Five Factor Model are also commonly known as OCEAN, an acronym that denotes Openness, Conscientiousness, Extraversion, Agreeableness, and Neuroticism. FIGS. 7A and 7B show these high-level human personality dimensions as a letter followed by a number, the number corresponding to one of the sub-facets of each dimension. For example, N means Neuroticism, and N1 means Anxiety, a sub-facet of Neuroticism (the N of neuroticism should not be confused the symbol N used in FIGS. 4A-4E and the descriptions thereof), and under each sub-facet are shown the psychometric items that correspond to it in this particular psychometric instrument. The “+” and “−” in front of each trait indicate positive and negative phrasing of the psychometric trait, which are also known as “pro-trait” and “con-trait” items respectively. As is common practice in psychometrics, in one embodiment, the numeric answer to a con-trait (−) psychometric item is multiplied by −1 before calculating scores.

In one embodiment, the user-response system used in obtaining purely psychometric dimensions from the N4 users in step 282 for these items is a 7-point so-called Likert Scale, consisting of the answers “Strongly Disagree,” “Disagree,” “Slightly Disagree,” “Neutral,” “Slightly Agree,” “Agree,” and “Strongly Agree.” We score these as −3, −2, −1, 0, 1, 2, and 3, respectively, when they're in the pro-trait direction, and multiply these scores by −1 when items are in the con-trait direction.

### Demographic Dimensions

Different embodiments may use different demographic dimensions in the psychometric profile, which includes the purely psychometric dimensions and also the demographic dimensions. One embodiment uses the following 15 demographic dimensions and answers (answers are shown in parentheses):
Gender (male, female)
Birth year (drop-down menu of years)
Birth order (1, 2, 4, 4, 5+)
Political affiliation (Green, Democrat, lean Democrat, moderate, lean Republican, Republican, Tea Party, Libertarian)
Race, click all that apply (White/non-Hispanic, Hispanic, Black/non-Hispanic [African American, African], Asian [East Asian, South Asian, Southeast Asian, Pacific Islander], Middle Eastern, Native American)
Religion (Mainline Protestant, Evangelical Protestant, Catholic, Eastern Orthodox, Mormon, Jewish, Muslim, Buddhist, Hindu, Sikh, other, agnostic, atheist)
How often do you attend regular religious services? (never, once a year or less, a few times a year, once or twice a month, almost every week, every week or more than once a week).
Have you ever been responsible for children as a parent or guardian (yes/no); if yes,
   How many children do you have? (1, 2, 4, 4, 5+)
   Is at least one of them a daughter? (yes/no)
Marital Status (never married, married, living with a partner, divorced/separated, widowed)
Education (high school or less, some college, college graduate, graduate degree)
Household Income (less than $20 k, $20-29,999, $30-49,999, $50-74,999, $75-99,999, $100-149,999, $150-249,999, $250-499,999, $500 k+)
Homeowner (own, rent, other)
Employment status (full-time, part-time, unemployed, retired)

In the psychometric models, both the purely psychometric dimensions and any demographic dimensions are modeled over a range, e.g., expressed as a probability between 0 and 100. For example, any user can have a “Sex” dimension between the most male and the most female. Similarly, “homeowner” in the psychometric model is expressed as a score between 0 and 100, denoting the probability of being a homeowner.

Thus, in one embodiment, P=45, with 30 purely psychometric and 15 demographic dimensions.

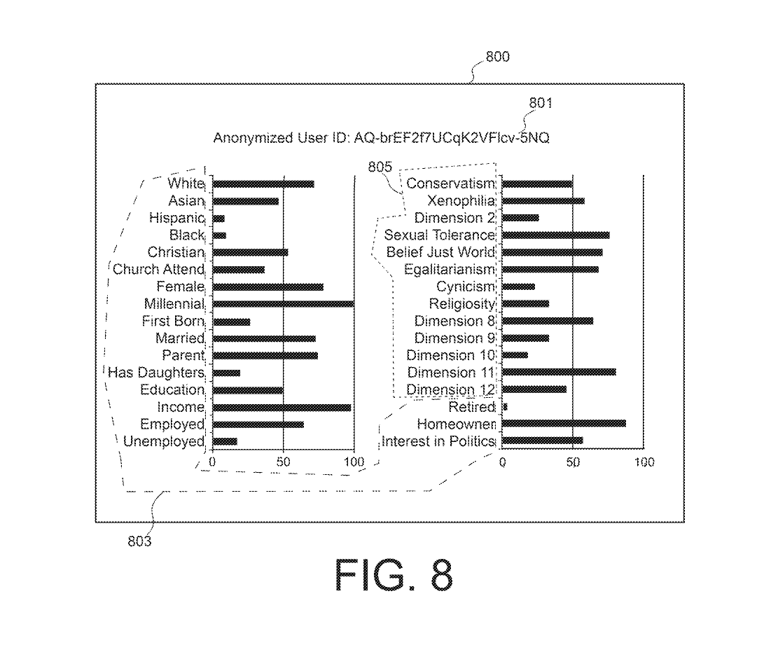

An alternate embodiment uses psychometric profiles that have 32 dimensions, of which 13 are purely psychometric and 19 are demographic. FIG. 8 is an illustrative example of such a 32-dimensional psychometric profile 800 of a user having an anonymized user ID 801. The purely psychometric dimensions are shown as set 805 and consist of conservatism; xenophilia; “Dimension 2;” sexual tolerance; belief just world; egalitarianism; cynicism; religiosity; “Dimension 8;” “Dimension 9,” “Dimension 10;” “Dimension 11;” and “Dimension 12,” where the dimensions called “Dimension n” where n is a digit are dimensions calculated from responses to psychometric items, e.g., in order to reduce the number of dimensions. The demographic dimensions are shown as set 803 and consist of white; Asian; Hispanic; black; Christian; church attend(ance); female; millennial; first born; married; parent; has daughters; education; income; employed; unemployed; retired; homeowner; and interest in politics.

In some versions, for each dimension, more than one item may be presented to the potential seed user. The purpose of collecting responses to multiple items for the same dimension serves two main purposes: it improves validation by enabling the checking for internal consistency among responses for each participant, and it enables the combining of multiple responses so that the responses within a given dimension can be averaged, which reduces noise in the subsequent modeling steps.

In step 482 of FIG. 4A, the psychometric analytics engine carries out additional balancing and validation of surveys. This includes, but is not limited to, checking for the following response patterns in order to ensure valid psychometric profiles:
Straight-lining—Participants that select the same value for each response (usually so they can complete the survey very quickly)
Speeders—Participants that finish surveys unreasonably quickly (e.g. by selecting random values that don't reflect actual viewpoints).
Acquiescence bias—Selecting positive values too often (when “honest” responses would typically be split more evenly positive and negative due to the way statements are structured).
Naysayer bias—Similar to above, except over-weighted by negative values.
Consistency—Does a user give the same or nearly the same response to an identical statement that is repeated during the survey?

The further balancing and validating results in N5 users, for which psychometric profiles are available. For each of the N5 users, say the u'th user for whom seed data is available, there is a topic vector tᵤ obtained from the data provider in step 424 (FIG. 4A) by the target population provider system 102 with anonymized user IDs provided by the data distributor system as step 448 (FIG. 4A). For each such u'th user, there is also a vector of P psychometric dimensions obtained for user u, denoted as pᵤ, forming the psychometric profiles. tᵤ=[tᵤ₁ tᵤ₂ . . . tᵤₖ . . . t_{uK}], and pᵤ=[pᵤ₁ pᵤ₂ . . . p_{uP}].

### The Machine-Learning of a Method of Obtaining the Psychometric Models

In one embodiment, each dimension of the psychometric profile, say the i'th dimension pᵤᵢ of the u'th user, i=1, . . . , P, is modeled as a function of the topic vector tᵤ of the user, such a function forming a model of the dimension. That is,

$$\begin{matrix}{p}_{ui} = {i}_{} ( {t}_{u} ) , i = 1 , … , P . \\ = {i}_{} ( {t}_{u 1} , {t}_{u 2 ,} … {t}_{uK} ) , i = 1 , … , P .\end{matrix}$$

At least one machine-learning method is used to learn each of the P functions [symbol] ᵢ, i=1, . . . , P. Each is a function of K variables. We call each such [symbol] ᵢ the model for the particular dimension.

For those embodiments in which summary behavioral data are in the form of topic vectors, recall there is seed data for N5 users, including the topic vectors obtained from the web browsing behavior (by an analysis process) and the survey responses (the psychometric profiles of actual measured pᵤᵢ values for each user u). For the machine-learning, the topic vectors are regarded as features, and each of the dimensions, pᵤᵢ are regarded as a “pattern” or classification for a supervised machine-learning classifier. Thus in some embodiments, the at least one machine-learning method comprises at least one supervised machine-learning classifier. Depending on the particular dimension being modeled, there are three types of classifications: binary classification (predicting one of two possible outcomes), multiclass classification (predicting one of more than two outcomes) and regression (predicting a numeric value). One embodiment comprises training a plurality of machine-learning methods, carries out cross-validation, e.g., so-called k-fold cross-validation, and selects a machine-learning method and corresponding model according to a machine-learning method selection criterion. In one embodiment, the selection of the model that provides the best performance according to a performance criterion. The criterion used depends on the type of classification. In one embodiment, 10-fold cross-validation is carried out for selecting the best-performance model. Other numbers of folds, of course, may be used in alternate embodiments.

Consider a binary classification dimension, say gender. One embodiment trains three binary machine-learning classifiers on the survey responses for gender using the topic vectors as features. The three binary machine-learning classifiers are logistic regression, naive Bayes, and random forests. The “best” model is selected by performing k-fold cross-validation, in particular, 10-fold cross-validation and choosing the model with the highest AUC (area under the ROC curve). The output from such a gender model is then the probability of a user being female (or equivalently the complement of the probability of being male).

Other dimensions of the psychometric profile that have two possible values are modeled in a similar way by determining the best model using the three different binary machine-learning classifiers. Note that other embodiments may select the best results from different classifiers, and/or from using a different number of possible classifiers, e.g., selected from the set consisting of support vector machines, logistic regression, decision trees, random forests, gradient-boosted trees, and naive Bayes.

Consider a multiclass classification dimension, say birth-order, which in one embodiment has five possible classifications. One embodiment converts each multi-class dimension modeling into a sequence of binary classifications. Three multiclass machine-learning classifiers on the survey responses for birth-order, converted to binary classifications are used: logistic regression, random forests, and naive Bayes, using the topic vectors as features. The “best” model is selected by performing k-fold cross-validation, e.g., 10-fold cross-validation, and choosing the model with the best performance, where the best performance in one embodiment is the model that achieves the highest AUC score.

Some dimensions are numerical values, and for each of these, while some embodiments may use linear regressions, one embodiment converts the modeling of a dimension that has numerical values into a sequence of classifications of which ranges of values a dimension falls into. This converts the modeling of a numerical-value dimension into multiclass classification of the dimension (a process which is sometimes called discretizing). As described above, multiclass classification is carried out by a series of binary classifications. As for the binary and multiclass classifiers, several machine-learning methods are used, and the best is selected using cross-validation.

### Engagement Modeling

As described above, some embodiments further include a method of using machine-learning to generate a model of engagement—an engagement model—with a stimulus as a function of a user's psychometric model. Some embodiments further include a method of using the engagement model with a population (with known psychometric models) to rank the population according to each user's likelihood of engagement. Some embodiments further include a method of generating audiences for the particular stimulus. The case of the stimulus being a single clickable online advertisement is described without limiting the invention to such a case.

As described above, the method includes collecting engagement data (and unengagement data) for the advertisement by randomly serving impressions of the advertisement and collecting data on which users click on the advertisement or don't click on the advertisement. The engagement of each user is treated as a response variable or outcome (e.g. 1 for clicked, 0 for didn't click). Engagement can also be a continuous variable (i.e. seconds spent watching a video advertisement before closing the page). Each user has a psychometric model, e.g., generated from online behavior as described above. Denote the model of a user u as pᵤ=[pᵤ₁ pᵤ₂ . . . p_{uP}].

One embodiment includes using logistic regression (or linear regression if the engagement model is not a binary valued quantity) to obtain the engagement model, with the engagement and unengagement data being the training data for the regression. The training data is used to learn a function, denoted E(pᵤ) that expresses the probability that a user whose psychometric model is Pᵤ engages with the particular advertisement. For binary data,

E(pᵤ)=1/1−e^{-t(p}^{ᵤ}⁾, where

t(pᵤ)=β₀+β₁pᵤ₁+β₂pᵤ₂ . . . β_{P}p_{uP}

and the psychometric model is:

pᵤ=[pᵤ₁pᵤ₂ . . . p_{uP}].

Applying the log it function to E(pᵤ),

$$logit ( E ( {p}_{u} ) ) = ln ( \frac{E ( {p}_{u} )}{1 - E ( {p}_{u} )} ) = {β}_{0} + {β}_{1} {p}_{u 1} + {β}_{2} {p}_{u 2} … . {β}_{P} {p}_{uP}$$

where ln( ) is the logarithm base e that generates the log-odds of engagement. The quantity [E(pᵤ)/1−E(pᵤ)] is the likelihood of engagement over the likelihood of unengagement, which is the odds ratio for engagement. Thus, the odds ratio is

odds-ratio=e^{β}^{₀}^{+β}^{₁}^{p}^{ᵤ₁}^{+β}^{₂}^{p}^{ᵤ₂} ^{. . . β}^{_{P}}^{p}^{_{uP}}.

For any dimension, say the i'th, the value of exp(βᵢ) is the odds ratio for engagement for pᵤᵢ, keeping all other dimensions constant. As an example, if the coefficient for the dimension gender of a psychometric profile is 0.69, then the odds of engagement for females is a factor of exp(0.69)=2 higher than that for males.

As an example of how such an engagement model may be used, FIGS. 9A and 9B show a graphical display of the results of determining an engagement model of users, using the 32-dimensional psychometric profiles of the example profile shown in FIG. 8. In the test whose results are shown in FIG. 8, there were 300 positive engagements and 42,000 negative engagements.

Considering FIG. 9A that shows the relative odds of engagement for purely psychometric traits, it can be see, for example, for the trait of religiosity (see encircled element 903) that religious users are approximately three times less likely to engage with this particular advertisement. Consider FIG. 9B, which shows the relative odds of engagement with the same ad for purely demographic traits; it can be see, for example, for the trait of being Hispanic (see encircled element 913) that Hispanics are 220% more likely to engage with this ad (given their prevalence in the population used), while for the trait of being female (see encircled element 915) that psychometrically female users are 270% more likely to engage with this ad. This can be used by clients to better target their advertisements according to one or more psychometric dimensions.

Some embodiments include running the learned engagement model on a population of users who may not have been exposed to the advertisement. This would typically be a large population of interest, and this process results in a measure of likelihood of engagement with the advertisement for the users of this larger population. Some versions include ranking members of the population according to predicted likelihood to engage, e.g., in descending order of likelihood to engage.

Some embodiments include partitioning the population into sets called population segments, also called audiences, wherein each set consists of those users within a particular ranked range of likelihoods, for example, the top 1% of users most likely to engage, from 2% to the top 5% in likelihood of engaging, and so forth. This provides a method for an advertiser to select one or more audiences (segments) of the population to whom to target an advertisement.

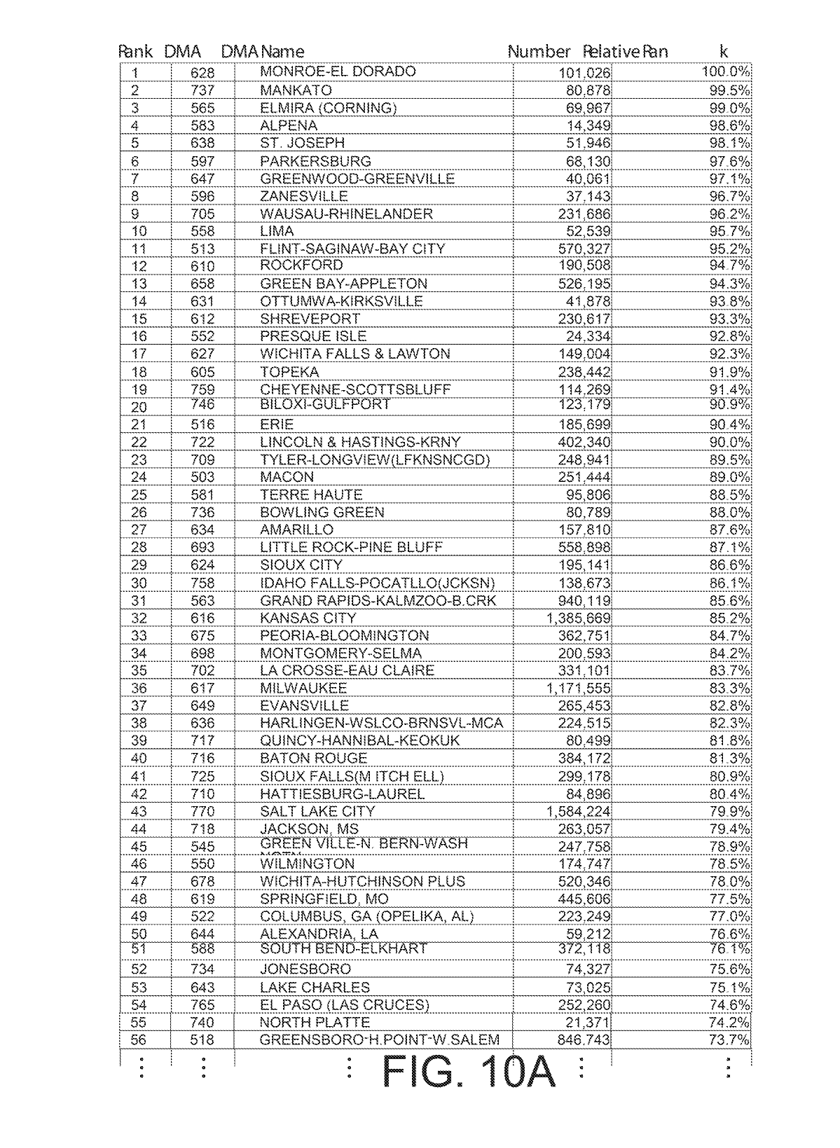

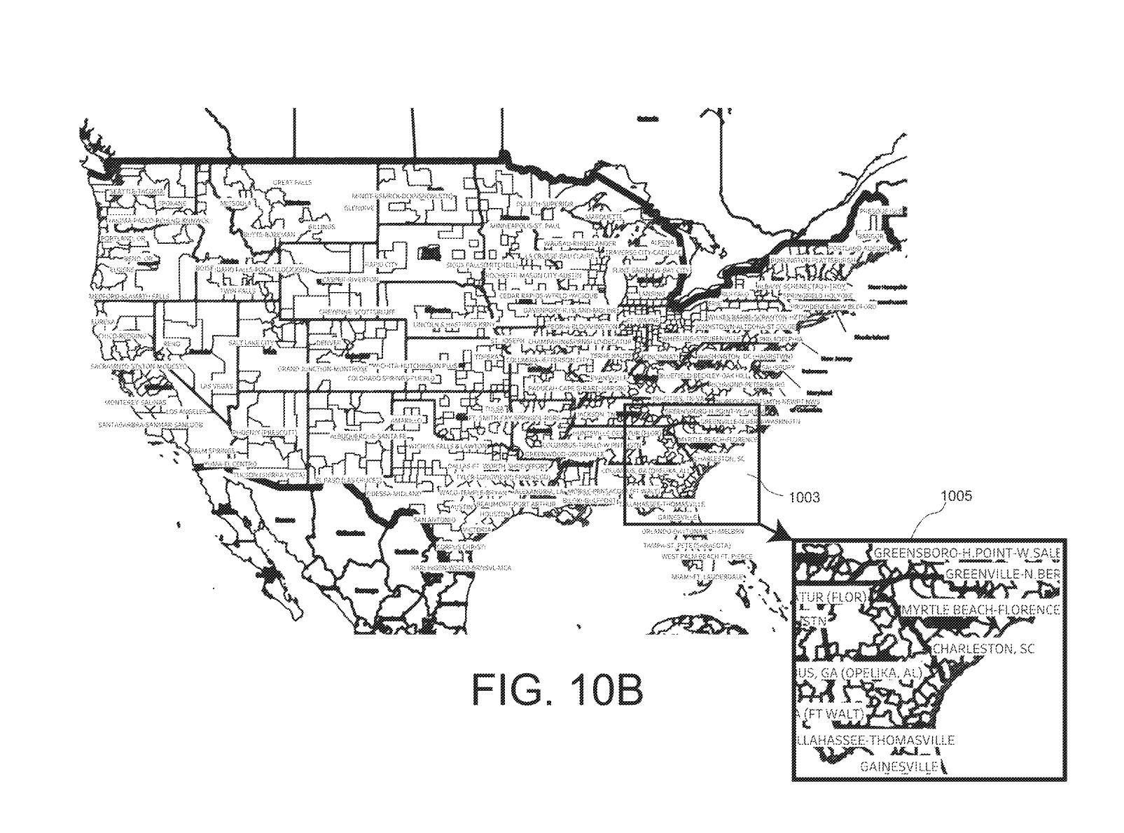

FIG. 10A shows an example of use of an embodiment of the invention for targeting a message by having the population on whom the engagement model is applied categorized according to their DMA. The segmenting of the ranked population can then be carried out according to the psychometric fit of each DMA with the ad. That is, the DMAs are ranked in descending likelihood of engagement, based on the average psychometric models of each geographical area. FIG. 10A shows in table form part of such a ranking of a population according to DMA for an experiment run on a population of about 150 million users using the 32 dimensions of the example shown in FIG. 8. This information can then be embedded in a map of DMAs to predict geographic areas according to their likelihood of engagement with the stimulus, e.g., an advertisement, based on an area's average psychometric fit with the engagement model of that advertisement. FIG. 10B shows a map of DMAs in the United States, wherein each DMA can be color coded according to its likelihood of engagement. The DMAs on the map are not meant to be readable in the drawing. However, one region 1003 is shown magnified in form 1005. Such information is usable for targeting advertisements.

### A Note on Anonymizing

The description herein mentions anonymized user IDs. For example, any target-provider user ID provided to PDAE 108 is anonymized, and any sample-provider user ID provided to PDAE 108 is anonymized. Many methods are known for anonymizing user ID's and other user data to remove any PII. One method of anonymizing includes concatenating or otherwise adding what is called “salt”, which is basically a random number to the information, and then applying a one-way function, e.g., a hash function to the combination of information and salt. Other methods also are known, for example, encrypting the information or information with salt using a secret key. The invention does not depend on any particular method of anonymizing. Furthermore, while the subject of whether anonymizing does a perfect job of anonymizing, or that anonymized data may be de-anonymized given sufficient time and/or computational power is a current subject of research and debate, for purposes of the present invention, anonymizing means using an anonymizing method, e.g., one that is currently practiced in data science.

### A Note on the Computing Environment and on Special Hardware

Note that FIG. 1 shows computing environment 100 that includes several systems, each shown, purely for simplicity of explanation, as having at least one processor and a storage subsystem. The systems may be operated by different entities, and several of the features of the invention are operated by or in PDAE 108. The invention however is not limited to the arrangement shown in FIG. 1. PDAE 108, for example, may be implemented as a system that includes at least one special-purpose machine, and/or that may use a set of virtual machines as part of a computer cluster provided via cloud computing. That is, some embodiments of the invention are implemented on a set of computer systems that may be at least one virtual machine that operates “in the cloud,” i.e., that operates at least one remote location, and if more than one location, the locations being coupled by an internet of networks to the Internet. For simplicity, all such computers are shown in FIG. 1 as a single system having at least one processor and a storage subsystem wherein data and program code is stored. Cloud computing as used herein means a type of Internet-based computing that provides shared computer processing resources and data to computers and other devices on demand over the Internet. Examples of providers of cloud computing include Amazon Inc.'s Amazon Web Services (“AWS”)®, Microsoft Corporation's Microsoft Azure®, IBM SoftLayer®, Google Cloud Platform™ and many others.

Note also that while this disclosure uses the term “database” and “records” of a database, it is to be understood that this term is used in the general sense to mean a data structure for maintaining data. Many such data structures are known and may be used in particular implementations. For example, relational (SQL) databases are commonly known and used. However, this invention is not limited to use such structures. Non-relational databases, also called non_SQL or noSQL databases (e.g. MongoDB), are also known and may be used. Data-warehouse-style data depositories also are known and may be used. Additionally, elastic cache memories (e.g. Redis) may be used to store data. All of these and more data structures are included in the term database as used herein.

Some embodiments of the invention, e.g., features and methods of PDAE 108, are implemented using a distributed cluster computing framework, in particular Amazon Elastic Map Reduce (“Amazon EMR”) in Amazon Web Services (“AWS”) run by Amazon, Inc. Amazon EMR is a managed cluster platform that allows clustering commodity hardware together to analyze massive data sets in parallel. A cluster is a collection of virtual machine instances called nodes, which in Amazon EMR are Amazon Elastic Compute Cloud (Amazon EC2) instances. Each instance (node) in the cluster is a virtual server machine having a role within the cluster. For example Amazon EMR provides a so-called master node that manages the cluster by running software components that coordinate the distribution of data and tasks among other nodes—collectively referred to as slave nodes—for processing. The master node tracks the status of tasks and monitors the health of the cluster. A so-called core node is a slave node that has software components that run tasks and store data, e.g., in a distributed file system such as the Apache Hadoop Distributed File System (HDFS) on the cluster, while a so-called task node (if used) is a slave node that has software components that only run tasks. Google (e.g. Google Cloud), Microsoft (e.g. Microsoft Azure), and potentially other future providers offer similar cloud-based services.

The inventor chose to implement many of the methods described herein using publicly available “open source” code. Some embodiments of the invention e.g., features and methods of PDAE 108 use the APACHE SPARK™ framework running over Amazon EMR, in particular machine-learning methods provided by APACHE SPARK™ as Apache Spark MLib. However, the invention is not limited to such an implementation. Furthermore, at this (circa 2016-2017) period of development of computer science, new platforms are being introduced that may also be suitable for implementing embodiments of the methods and systems described herein.

APACHE SPARK™ is referred to herein as Apache Spark, or simply as Spark, and is an open-source large-scale distributed processing framework which targets, inter alia, machine-learning iterative workloads. Spark uses a functional programming paradigm, and applies the functional programming paradigm on large clusters by providing a fault-tolerant implementation of distributed data sets called Resilient Distributed Data (RDD), each of which can reside in the main memory of the cluster (or in blocks of disks). The ability of storing the data in main memory enables computation to occur much faster than if the data was stored in physical disks. Spark also enables fault tolerant computing. Computation in Spark is expressed using functional transformations over RDDs. For more information on Apache Spark, see Zaharia, et al, “Apache Spark: A Unified Engine for Big Data Processing,” Communication of the ACM, vol. 49, No. 11, pp. 56-65, 2016.

In one embodiment, the machine-learning (ML) methods described herein in PDAE 108 use algorithms and utilities provided in Spark and part of Apache Spark's MLlib. Spark's MLlib provides methods usable for binary classification, logistic regression, naive Bayes, and others; for regression, generalized linear regression, survival regression, and others; for decision trees, random forests, and gradient-boosted trees; for alternating least squares (ALS); for clustering, K-means, Gaussian mixtures (GMMs), and other clustering techniques; for topic modeling: latent Dirichlet allocation (LDA); and for mining, frequent item sets, association rules, and sequential pattern mining. Spark also includes ML workflow utilities, including for feature transformations, standardization, normalization, hashing, and others; ML Pipeline construction methods; model evaluation methods; hyper-parameter tuning methods; and for ML persistence, methods for saving and loading models and Pipelines. Spark also has other utilities including for distributed linear algebra: SVD, PCA, and others; and for statistics, summary statistics, hypothesis testing, and other statistical methods.

It should be clear to those of ordinary skill in the art that alternate embodiments of the invention can be built by writing special purpose programs rather than using methods available as open-source code, and also by using available methods other than and/or in addition to those provided by Apache Spark. One example of alternate code is “sci-kit learn,” a set of machine-learning algorithms in Python which can operate on the Google Cloud. See, for example, scikit-learn˜dot˜org/stable/ retrieved 2016 Jun. 6, where ˜dot˜ denotes the period (“.”) character in the actual URL.

For the hardware system of FIG. 6, some embodiments of the engines that use logic elements use gate arrays (FPGAs). One version uses Xilinx Zynq-7000s all programmable system on a chip that each contains two ARM Cortex-A9 processor cores, and a Partial Reconfigurable Region, made by Xylinx, Inc. of San Jose, Calif., USA. The machine-learning engine, for example, uses FPGAs to implement naïve Bayes machine-learning and random forest machine-learning. See for example Sun-Wook Choi and Chong Ho Lee, A FPGA-based parallel semi-naive Bayes classifier implementation, IEICE Electronics Express, Vol. 10 (2013) No. 19 p. 20130673, retrieved 2017 May 30 at www˜dot˜jstage˜dot˜jst˜dot˜go˜dot˜ip/article/elex/10/19/10_10˜dot˜20130673/pdf, where ˜dot˜ denotes the period (“.”) character in the actual URL, and Van Essen, Brian, Chris Macaraeg, Maya Gokhale, and Ryan Prenger. “Accelerating a random forest classifier: Multi-core, GP-GPU, or FPGA?.” 2012 IEEE 20th Annual International Symposium on Field-Programmable Custom Computing Machines (FCCM), pp. 232-239. IEEE, 2012.

### GENERAL

Unless specifically stated otherwise, as apparent from the following discussions, it is appreciated that throughout the specification discussions utilizing terms such as “processing,” “computing,” “calculating,” “determining,” or the like, these terms refer to the action and/or processes of a host device or computing system, or similar electronic computing device, that manipulates and/or transforms data represented as physical, such as electronic, quantities into other data similarly represented as physical quantities.

In a similar manner, the term “processor” may refer to any device or portion of a device that is programmable via machine-readable instructions and that processes electronic data, e.g., from registers and/or memory, to transform that electronic data into other electronic data that, e.g., may be stored in registers and/or memory.

The term “a set of none or more elements” means a set which may have no elements or at least one element, and therefore includes the possibility of one element, more than one element, or an empty set of no elements. It is a term in common usage by those skilled in the art of computer science.

The methodologies described herein are, in one embodiment, performable by at least one processor that accepts machine-readable instructions, e.g., as firmware or as software, that when executed by at least one processor carry out at least one of the methods described herein. In such embodiments, any processor capable of executing a set of instructions (sequential or otherwise) that specify actions to be taken may be included. Thus, one example is a programmable DSP device. Another is the CPU of a microprocessor or other computer-device, or the processing part of a larger ASIC. A processing system may include a storage subsystem including memory such as main RAM and/or a static RAM, and/or ROM, and at least one other storage device. A bus subsystem may be included for communicating between the components. The processing system further may be a distributed processing system with processors coupled wirelessly or otherwise, e.g., by a network. The processing system also may be part of a cluster, and may be provided “in the cloud” as cloud-based service.

If the processing system requires a display, such a display may be included. The processing system in some configurations may include a sound input device, a sound output device, and a network interface device.

The processing system's storage subsystem thus includes a machine-readable non-transitory medium that is coded with, i.e., has stored therein a set of instructions to cause performing, when executed by at least one processor, at least one of the methods described herein.

Note that when the method includes several elements, e.g., several steps, no ordering of such elements is implied, unless specifically stated. The instructions may reside in the hard disk, or may also reside, completely or at least partially, within the RAM and/or other elements within the processor during execution thereof by the system. Thus, the memory and the processor also constitute the non-transitory machine-readable medium with the instructions.

Furthermore, a non-transitory machine-readable medium may form a software product. For example, it may be that the instructions to carry out some of the methods, and thus form all or some elements of the inventive system or apparatus, may be stored as firmware. A software product may be available that contains the firmware, and that may be used to “flash” the firmware.

Note that while some diagram(s) only show(s) a single processor and a single storage subsystem, e.g., memory that stores the machine-readable instructions and other storage, those in the art will understand that many of the components described above are included, but not explicitly shown or described, in order not to obscure the inventive aspect. For example, while only a single machine is illustrated, the term “machine” shall also be taken to include any collection of machines that individually or jointly execute a set (or multiple sets) of instructions to perform any at least one of the methodologies discussed herein.

Thus, one embodiment of each of the methods described herein is in the form of a non-transitory machine-readable medium coded with, i.e., having stored therein a set of instructions for execution on at least one processor.

Note that, as is understood in the art, a machine with application-specific firmware for carrying out at least one aspect of the invention becomes a special purpose machine that is modified by the firmware to carry out at least one aspect of the invention. This is different than a general-purpose processing system using software, as the machine is especially configured to carry out at least one aspect. Furthermore, as would be known to one skilled in the art, if the number of units to be produced justifies the cost, any set of instructions in combination with elements such as the processor may be readily converted into a special purpose ASIC or custom integrated circuit. Methodologies and software exist that accept the set of instructions and particulars of, for example, the processing engine 180, and automatically or mostly automatically create a design of special-purpose hardware, e.g., generate instructions to modify a gate array or similar programmable logic, or that generate an integrated circuit to carry out the functionality previously carried out by the set of instructions. Thus, as will be appreciated by those skilled in the art, embodiments of the present invention may be embodied as a method, an apparatus such as a special purpose apparatus, an apparatus such as a data DSP device plus firmware, or a non-transitory machine-readable medium. The machine-readable carrier medium carries host device readable code, including a set of instructions that when executed on at least one processor cause the processor or processors to implement a method.

Accordingly, aspects of the present invention may take the form of a method, an entirely hardware embodiment, an entirely software embodiment, or an embodiment combining software and hardware aspects. Furthermore, the present invention may take the form a computer program product on a non-transitory machine-readable storage medium encoded with machine-executable instructions.

Reference throughout this specification to “some embodiments,” “one embodiment,” “embodiments,” or “an embodiment” means that a particular feature, structure, or characteristic described in connection with the embodiment is included in at least one embodiment of the present invention. Thus, appearances of the phrases “in some embodiments,” “in one embodiment,” “in an embodiment,” or similar statements in various places throughout this specification are not necessarily all referring to the same embodiment, but may. Furthermore, the particular features, structures or characteristics may be combined in any suitable manner, as would be apparent to one of ordinary skill in the art from this disclosure, in at least one embodiment.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Similarly it should be appreciated that in the above description of example embodiments of the invention, various features of the invention are sometimes grouped together in a single embodiment, figure, or description thereof for the purpose of streamlining the disclosure and aiding in the understanding of at least one of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a host device system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Conjunctive language, such as phrases of the form “at least one of A, B, or C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B or C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. Similarly, “A, B, and/or C” refer to any of the following sets {A}, {B}, {C}, {A, B}, {A, C}, {B, C}, {A, B, C}.

All publications, patents, and patent applications cited herein are hereby incorporated herein by reference in any jurisdiction in which such incorporation by reference is permitted. In any jurisdiction which does not permit such incorporation by reference, Applicant reserves the right to insert material from any such publication, patent, and/or patent application that is or are cited herein without such insertion being considered as adding new matter to the description.

Any discussion of prior art in this specification should in no way be considered an admission that such prior art is widely known, is publicly known, or forms part of the general knowledge in the field.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, “including” is synonymous with and means “comprising.”

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the invention as claimed, and it is intended to claim all such changes and modifications. For example, any formulas given above are merely representative of procedures that may be used. Functionality may be added or deleted from the block diagrams, and operations may be interchanged among functional blocks. Steps may be added or deleted to methods described within the present invention as claimed.

Note that the claims attached to this description form part of the description, so are incorporated by reference into the description in any jurisdiction that allows such incorporation of the claims by reference, each claim forming a different set of at least one example embodiment. For any jurisdictions that does not permit such incorporation by reference, Applicant reserves the right to insert the claims herein as sets of example embodiments without such insertion being considered as adding new matter.

What is claimed is:

1. A machine-implemented method comprising:
(a) accepting automatically-machine-collected data about online behavior of users of a first set of users;
(b) accepting measured psychometric dimensions of users of the set of users to form accepted and measured psychometric profiles of users of the first set, each psychometric profile comprising a set of dimensions including at least one purely psychometric dimension and optionally at least one demographic dimension, the measured psychometric dimension obtained from a measuring instrument;
(c) using the accepted data about online behavior and the corresponding accepted measured psychometric profiles of the users of the first set to train at least one machine-learning method of predicting psychometric profiles of users whose psychometric profiles may be unknown, the at least one method of predicting for any user whose psychometric profile may be unknown using automatically-machine-collected data about online behavior of the user whose psychometric profile may be unknown;
(d) accepting automatically-machine-collected data about online behavior of users of a population of users whose psychometric profiles may be unknown, the accepted automatically-machine-collected data excluding any personally identifiable information;
(e) using at least one of the trained at machine-learning method of predicting to generate psychometric models of each of the population of users from the accepted data about online behavior of the users of the population; and
(f) storing the predicted psychometric models,
wherein no personally identifiable information of users of the population needs to be used or maintained, such that the method is able to maintain anonymity of each of the users of the population of users.

2. The machine-implemented method of claim 1, wherein the accepted psychometric profile of each of the users of the first set is measured by sending said each user to the measuring instrument for data entry by said each user, such that the method can maintain ignorance of personally identifiable information of users of the first set.

3. The machine-implemented method of claim 2, wherein access to the users of the first set for sending the users of the first set to the measuring instrument is provided by a sample provider system in which users of the first-set of users have sample-provider user IDs, any sample-provider user IDs provided to the method being anonymous or being anonymized prior to being provided to the method.

4. The machine-implemented method of claim 3, wherein the sample provider system has demographic information on its users, and wherein the users of the first set are users of the sample provider that have been demographically selected according to at least one demographic criterion.

5. The machine-implemented method of claim 3, wherein the accepting of automatically-machine-collected data about online behavior includes accepting of automatically-machine-collected data about online behavior of a second set of users that includes the first set of users, wherein each user of the second set has a target-population-provider user ID, and wherein the target-population-provider user ID of any user of the first set is different from said any user's sample-provider user ID, any target-population-provider user ID that is provided to the method being anonymous or being anonymized prior to being provided to the method, such that the method can maintain ignorance of personally identifiable information of users of the first set or the second set.

6. The machine-implemented method of claim 1, wherein the users of the first set of users are selected to have valid psychometric profiles, the selecting being from users whose psychometric profiles have been collected.

7. The machine-implemented method of claim 1, further comprising carrying out an analysis process on the accepted automatically machine-collected data about online behavior of the first set to form summary data about online behavior.

8. The machine-implemented method of claim 7, wherein the analysis process comprises unsupervised classification.

9. The machine-implemented method claim 7, wherein the automatically-machine-collected data about online behavior of a respective user of the first set comprises respective text from online behavior by said respective user, and the analysis process comprises analyzing the text.

10. The machine-implemented method of claim 9, wherein the respective text is of respective websites visited by said respective user.

11. The machine-implemented method of claim 9, wherein the analysis process comprises topic modeling to form a number of topics from the respective text for each user.

12. The machine-implemented method of claim 7 wherein the automatically-machine-collected data about online behavior of a respective user of the first set comprises at least one respective image and/or at least one audio element from online behavior by said respective user, and the analysis process comprises analyzing the at least one respective image and/or the at least one audio element.

13. The machine-implemented method of claim 1, wherein said training of at least one machine-learning method of predicting comprises training a plurality of machine-learning methods and selecting for each dimension a particular machine-learning method.

14. The machine-implemented method of claim 13 wherein the selecting comprises carrying out cross-validation.

15. The machine-implemented method of claim 1, wherein the at least one machine-learning method comprises at least one of the set consisting of support vector machines, logistic regression, decision trees, random forests, gradient-boosted trees, and naive Bayes.

16. The machine-implemented method of claim 1, further comprising a machine-implemented method of determining a model that predicts a likelihood of engagement with a particular stimulus by respective online users as a function of the respective psychometric models of the respective users, the method of predicting comprising:
accepting from an engagement-measuring instrument engagement data on users who engage with the particular stimulus and for whom psychometric models are stored;
retrieving stored psychometric models of users whose engagement data are accepted; and
training at least one machine-learning method to determine an engagement model that predicts a measure of the likelihood of engagement for a user whose engagement data may be unknown, based on the psychometric model of the user whose engagement data may be unknown, the training using both accepted engagement data on the users whose psychometric models are retrieved and the retrieved psychometric models.

17. The machine-implemented method of any claim 16, further comprising applying the engagement model to carry at least one of the set of actions consisting of targeting the particular stimulus to users having at least one particular psychometric dimension, and comparing the engagement model for the particular stimulus to at least one engagement model for at least one other particular stimulus.

18. A machine-implemented method comprising:
accepting from an engagement-measuring instrument engagement data on users who engage with a particular stimulus and for whom predicted psychometric models are stored;
retrieving stored psychometric models of users whose engagement data are accepted; and
training at least one machine-learning method to determine an engagement model that predicts a measure of a likelihood of engagement for a user whose engagement data may be unknown, based on the psychometric model of the user whose engagement data may be unknown, the training using both accepted engagement data on the users whose psychometric models are retrieved and the retrieved psychometric models,
wherein each psychometric model of a specific user is a predicted psychometric profile of the user, and comprises a set of dimensions including at least one purely psychometric dimension and optionally at least one demographic dimension of the user, obtained while maintaining ignorance of personally identifiable information on the specific user.

19. The machine-implemented method of claim 18, further comprising applying the engagement model to a population of users whose psychometric models are available to predict respective measures of the likelihood of engagement with a particular stimulus for respective users of the population.

20. The machine-implemented method of claim 19, further comprising ranking the population of users according to the measure.

21. The machine-implemented method of claim 20, further comprising partitioning the ranked population into a set of audiences, each respective audience consisting of respective users of a respective range in the ranking.

22. The machine-implemented method of claim 18, further comprising applying the engagement model to carry at least one of the set of actions consisting of targeting the particular stimulus to users having at least one particular psychometric dimension, and comparing the engagement model for the particular stimulus to at least one engagement model for at least one other particular stimulus.

23. A system comprising:
(a) a measuring instrument configured to measure psychometric dimensions of users;
(b) a psychometric data analytics engine (PDAE) coupled to the measuring instrument, the PDAE comprising:
(i) a processor set comprising at least one processor; and
(ii) a storage subsystem,
wherein the storage subsystem comprises a non-transitory machine-readable medium having stored therein code (187, 188, 189) that when executed by at least one processor of the processor set, carries out a method comprising:
(a) accepting automatically-machine-collected data about online behavior of users of a first set of users;
(b) accepting measured psychometric dimensions of users of the set of users to form accepted and measured psychometric profiles of users of the first set, each psychometric profile comprising a set of dimensions including at least one purely psychometric dimension and optionally at least one demographic dimension, the measured psychometric dimension obtained from a measuring instrument;
(c) using the accepted data about online behavior and the corresponding accepted measured psychometric profiles of the users of the first set to train at least one machine-learning method of predicting psychometric profiles of users whose psychometric profiles may be unknown, the at least one method of predicting for any user whose psychometric profile may be unknown using automatically-machine-collected data about online behavior of the user whose psychometric profile may be unknown;
(d) accepting automatically-machine-collected data about online behavior of users of a population of users whose psychometric profiles may be unknown, the accepted automatically-machine-collected data excluding any personally identifiable information;
(e) using at least one of the trained at least one machine-learning method of predicting to generate psychometric models of each of the population of users from the accepted data about online behavior of the users of the population; and
(f) storing the predicted psychometric models,
wherein no personally identifiable information of users of the population needs to be used or maintained, such that the method is able to maintain anonymity of each of the users of the population of users.

24. The system of claim 23, wherein the accepted psychometric profile of each of the users of the first set is measured by sending said each user to the measuring instrument for data entry by said each user, such that the method can maintain ignorance of any personally identifiable information of users of the first set.

25. The system of claim 23, wherein the method further comprises carrying out an analysis process on the accepted automatically machine-collected data about online behavior of the first set to form the summary data about online behavior.

26. The system of claim 23, wherein the method further comprises a method of determining a model that predicts a likelihood of engagement with a particular stimulus by respective online users as a function of the respective psychometric models of the respective users, the method of determining a model that predicts comprising:
accepting from an engagement-measuring instrument engagement data on users who engage with the particular stimulus and for whom psychometric models are stored;
retrieving stored psychometric models of users whose engagement data are accepted; and
training at least one machine-learning method to determine an engagement model that predicts a measure of the likelihood of engagement for a user whose engagement data may be unknown, based on the psychometric model of the user whose engagement data may be unknown, the training using both accepted engagement data on the users whose psychometric models are retrieved and the retrieved psychometric models.

27. The system of claim 26, wherein the method of determining a model that predicts further comprises applying the engagement model to carry at least one of the set of actions consisting of targeting the particular stimulus to users having at least one particular psychometric dimension, and comparing the engagement model for the particular stimulus to at least one engagement model for at least one other particular stimulus.

28. A system comprising:
(a) a measuring instrument configured to measure psychometric dimensions of users;
(b) a psychometric data analytics engine (PDAE) coupled to the measuring instrument, the PDAE comprising:
(i) a controller;
(ii) a storage subsystem coupled to the controller;
(iii) an interface coupled to the controller and the storage subsystem, and configured to interface the PDAE with at least the measuring instrument and a network,
the interface under control of the controller being configured to accept from the measuring instrument measured psychometric dimensions of users of a first set of users to form accepted psychometric profiles of users of the first set, each psychometric profile comprising a set of dimensions including at least one purely psychometric dimension and optionally at least one demographic dimension,
the interface under control of the controller further being configured to accept via the network automatically-machine-collected data about online behavior of users of a second set of users to form summary data about online behavior, each user of the second set also being in the first set;
(iv) a machine-learning engine coupled to the controller and configured to carry out at least one machine-learning method; and
(v) a psychometric engine coupled to the controller and the machine-learning engine, and configured under control of the controller to use the summary data about online behavior and the corresponding accepted measured psychometric profiles of the users of the second set to cause training, using the machine-learning engine, of at least one respective machine-learning method of predicting each respective dimension of psychometric profiles of users whose psychometric profiles may be unknown,
wherein the interface, under control of the controller also is configured to accept automatically-machine-collected data about online behavior of users of a third set of users whose psychometric profiles may be unknown, to form summary data about online behavior of the users of the third set,
wherein the PDAE, under control of the controller is configured to use at least one of the trained machine-learning methods of predicting to generate psychometric models of each of the third set of users from the summary data about online behavior of the users of the third set, and to store the predicted psychometric models, and
wherein the PDAE is configured to maintain ignorance of personally identifiable information of each of the users of the first, second, and third sets of users.

29. The system of claim 28, wherein the measuring instrument carries out measurement by data entry by the users of the first set.

30. The system of claim 29, wherein the accepted psychometric profile of each of the users of the first set is measured from each user of the first set by sending the user to the measuring instrument for data entry by the user, such that ignorance of any personal identifiable information of the users of the first set is maintained in the PDAE.

31. The system of claim 28, wherein the PDAE further comprises:
an analysis engine coupled to the controller and the storage subsystem, and configured to carry out a data analysis process on the accepted automatically machine-collected data on online behavior of users to form the summary data about online behavior (111, 113).

32. The system of claim 31, wherein the automatically machine-collected data about online behavior of a respective user of the second set comprises respective text from online behavior by said respective user, and the data analysis process comprises analyzing the text.

33. The system of claim 32, wherein the data analysis process comprises topic modeling to form a number of topics from the respective text from online behavior for each user.

34. The system of claim 28,
wherein the PDAE also is configured to carry out using psychometric models of users and engagement data to form a model to predict a likelihood of engagement with a particular stimulus,
wherein the interface under control of the controller is configured to accept from an engagement-measuring instrument engagement data on users who engage with the particular stimulus and for whom predicted psychometric models are available,
wherein the controller of the PDAE is coupled to and configured to control an engagement-modeling engine that is coupled to the machine-learning engine and the storage subsystem, and configured to retrieve stored psychometric models of users whose engagement data are accepted, and
wherein the engagement-modeling engine is further configured to cause the machine-learning engine to use both accepted engagement data on the users whose psychometric models are retrieved and the retrieved psychometric models to train at least one of the machine-learning engine's machine-learning methods to determine an engagement model that predicts a measure of the likelihood of engagement for a user whose engagement data may be unknown, based on the psychometric model of the user whose engagement data may be unknown.

35. The system of claim 34, wherein the engagement modeling engine further is configured to apply the engagement model to a population of users whose psychometric models are available to predict respective measures of the likelihood of engagement with the particular stimulus for respective users of the population.
